(19) United States
(12) Patent Application Publication
(10) Pub. No.: US 2024/0234116 A1
(43) Pub. Date: Jul. 11, 2024

(54) Integrated oscillating field ION spectrometry device and method of using the same

(71) Applicant: Volatylix, Inc., Cambridge, MA (US)

(72) Inventors: Kenneth A. MARKOSKI, Hudson, MA (US); Erkinjon G. NAZAROV, Tampa, FL (US); Clayton J. MORRIS II, Norfolk, MA (US)

(21) Appl. No.: 18/150,645

(22) Filed: Jan. 5, 2023

(51) Int. Cl. H01J 49/02; G01N 27/622

(52) U.S. Cl. CPC H01J 49/022; G01N 27/622; H01J 49/025

(57) ABSTRACT

An integrated oscillating field ion spectrometry device includes an ionization segment, filtering segment, and detection segment arranged in order. The filtering segment is located after the ionization segment and the detection segment is located after the filtering segment in the carrier gas flow direction. The ionization segment includes an ionizing tool and ionization region electrodes. The carrier gas moves material vapor through the ionizing tool to ionize the material vapor. Two parallel filter electrodes of the filtering segment that receive first DC voltages of opposite polarity and an RF oscillating voltage, filter ions from the carrier gas. Two parallel detector electrodes in the detection segment that are connected to a detection system receive second DC voltages. Ion guidance electrodes surround a periphery of the detector electrodes. The DC voltages and the RF oscillating voltage are selected to optimize detection of the specific ions of interest for a particular application.

### STATEMENT REGARDING FEDERALLY SPONSORED RESEARCH OR DEVELOPMENT

This invention was made with government support under grant number R44AI141264 awarded by the National Institute of Allergy and Infectious Diseases. The government has certain rights in this invention.

### BACKGROUND

The ability to detect and identify different materials including biomarkers of infection and disease, drugs, dangerous chemicals, biological agents, and air pollution has become increasingly more important for safety and wellbeing of human beings. Mass spectrometry and field asymmetric ion mobility spectrometry (FAIMS) (or IMS or DMS) have been used to detect and identify different materials. Improved detection methods and portable, less expensive material detection and identification methods and devices are desirable.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIGS. 1A, 1B, and 1C show an oscillating field ion spectrometry (OFIS) system including an integrated OFIS device and periphery apparatuses of the integrated OFIS device and a waveform of periodic strong asymmetric RF voltage applied to the OFIS device.

FIG. 2A shows a top plan view of a three segment integrated OFIS device. FIG. 2B shows a cross sectional view along line B-B in FIG. 2A and FIG. 2C shows a cross sectional view along line C-C. FIG. 2D shows a top plan view of a two segment integrated OFIS device.

FIG. 2E shows a cross sectional view along line D-D in FIG. 2D. FIG. 2F is a cross sectional view illustrating the movement of the ions according to embodiments of the present disclosure.

FIGS. 3A, 3B, 3C, 3D, and 3E show integrated OFIS devices according to embodiments of the present disclosure.

FIG. 4 shows a flow diagram of a method for operating an OFIS device in accordance with some embodiments of the present disclosure.

FIGS. 5A, 5B, and 5C show an ionization segment of the integrated OFIS device.

FIG. 6 shows a flow diagram of a method for operating an OFIS system in accordance with some embodiments of the present disclosure.

FIG. 7 shows a flow diagram of a method for operating an OFIS system in accordance with some embodiments of the present disclosure.

### SUMMARY

According to some embodiments of the present disclosure, an integrated oscillating field ion spectrometry device includes a chamber divided into at least three connected segments that comprises an ionization segment, a filtering segment, and a detection segment arranged in order, wherein the filtering segment is located downstream from the ionization segment in a direction of flow of a carrier gas, and the detection segment is located downstream from the filtering segment in the direction of flow of the carrier gas. The ionization segment includes a first opening and a second opening, wherein the carrier gas flows through the first opening into a first channel region in the ionization segment, and a material vapor flows through the second opening into the first channel region of the ionization segment. An ionizing tool is mounted in the first channel region configured to ionize the material vapor. Two parallel ionization region electrodes on opposing walls of the first channel region, wherein the two parallel ionization region electrodes are connected to a first DC voltage source or to ground, and the two parallel ionization region electrodes are configured to prevent charging of dielectric surfaces in the ionization segment. The filtering segment includes two parallel filter electrodes on opposing walls of a second channel region of the filtering segment that are parallel to the direction of flow of the carrier gas. The two parallel filter electrodes are connected to a second DC voltage source to receive second DC voltages of opposite polarity, the two parallel filter electrodes are connected to a radio frequency (RF) voltage source to receive an RF oscillating voltage in addition to the second DC voltages. The two parallel filter electrodes are configured to generate electric fields by the second DC voltages and the RF oscillating voltage to filter ions passed from the ionization segment. The detection segment includes two parallel detector electrodes on opposing walls of a third channel region of the detection segment that are parallel to the direction of flow of the carrier gas. The two parallel detector electrodes are connected to a third DC voltage source to receive third DC voltages and are connected to a detection system. The two parallel detector electrodes are configured to generate an electric field by the third DC voltages to attract filtered material vapor ions. Two parallel ion guidance electrodes are on opposing walls of the third channel region, wherein the ion guidance electrodes surround a periphery of the detector electrodes. The two parallel ion guidance electrodes are connected to a fourth DC voltage source to receive fourth DC voltages, and the two parallel ion guidance electrodes are configured to generate an electric field to guide ions to the two parallel detector electrodes. The detection segment is configured to count a number of positive and negative ions of the material vapor. The first channel region, the second channel region, and the third channel region are arranged along a line and form a single channel. In an embodiment, the integrated oscillating field ion spectrometry device includes a first interface between the ionization segment and the filtering segment, wherein the ionization segment has a transition region next to the first interface, and a width of the transition region is tapered from a first width to a second width, wherein the second width is a width of the first interface, and the second width is between 2 to 5 times smaller than the first width. In an embodiment, the integrated oscillating field ion spectrometry device includes one or more ground shields on an outer surface of the detection segment. In an embodiment, the integrated oscillating field ion spectrometry device includes a viewing window, and an ionization zone is viewable from the viewing window. In an embodiment, the ionizing tool includes a plasma source, such as a cross-wire capacitive discharge device. In an embodiment, in an electric field generated by the second DC voltages of opposite polarity in the second channel region has a direction that is opposite to the electric field generated by the third DC voltages in the third channel region. In an embodiment, outside walls of the chamber include a plurality of connection pads electrically connected to each one of the two parallel ionization region electrodes, the two parallel filter electrodes, the two parallel detector electrodes, the two parallel ion guidance electrodes, and the ionizing tool. In an embodiment, the integrated oscillating field ion spectrometry device includes a control system that is coupled to the first, second, third, and fourth DC voltage sources, the RF voltage source, and the detection segment, wherein, the control system is configured to control the second DC voltage source to adjust the second DC voltages and to adjust an amplitude or a frequency of the RF oscillating voltage of the RF voltage source, and configured to control the first DC voltages, the third DC voltages, and the fourth DC voltages. In an embodiment, an electric field generated by the second DC voltages of opposite polarity in the second channel region has a direction that is a same direction as the electric field generated by the third DC voltages in the third channel region. In an embodiment, the ionization segment includes a first opening and a second opening, wherein the carrier gas flows through the first opening into the ionization segment, and the material vapor flows through the second opening into the ionization segment.

According to some other embodiments of the disclosure, an oscillating field ion spectrometry system includes an integrated oscillating field ion spectrometry device and an ionization device coupled along a gas flow to the integrated oscillating field ion spectrometry device. The ionization device includes an ionizing tool mounted in the ionization device, wherein the ionizing tool is configured to ionize a material vapor and two parallel ionization region electrodes on opposing walls of the ionization device. The two parallel ionization region electrodes are connected to a first DC voltage source or to ground, and the two parallel ionization region electrodes are configured to prevent charging of dielectric surfaces in the ionization device. The integrated oscillating field ion spectrometry device includes a chamber divided into at least two connected segments comprising a filtering segment and a detection segment arranged in order. The detection segment is located after the filtering segment in a direction of flow of a carrier gas and the filtering segment is located downstream from the ionization device. The filtering segment includes two parallel filter electrodes on opposing walls of a first channel region of the filtering segment that are parallel to the direction of flow of the carrier gas. The two parallel filter electrodes are connected to a second DC voltage source to receive second DC voltages of opposite polarity and the two parallel filter electrodes are connected to a radio frequency (RF) voltage source to receive an RF oscillating voltage in addition to the second DC voltages. The two parallel filter electrodes are configured to generate electric fields by the second DC voltages and the RF oscillating voltage to filter ions passed from the ionization device. The detection segment includes two parallel detector electrodes on opposing walls of a second channel region of the detection segment that are parallel to the direction of flow of the carrier gas. The two parallel detector electrodes are connected to a third DC voltage source to receive third DC voltages and are connected to a detection system. The two detector parallel electrodes are configured to generate an electric field by the third DC voltages to attract material vapor ions, wherein the detection system is configured to determine a number of positive and negative ions of the material vapor. Two parallel ion guidance electrodes are on opposing walls of the second channel region, wherein the ion guidance electrodes surround a periphery of the detector electrodes. The two parallel ion guidance electrodes are connected to a fourth DC voltage source to receive fourth DC voltages, and the two parallel ion guidance electrodes are configured to generate an electric field to guide ions to the two parallel detector electrodes. In an embodiment, the first channel region and the second channel region are arranged along a line and form a single channel. In an embodiment, an electric field generated by the second DC voltages of opposite polarity in the first channel region has a direction that is opposite to the electric field generated by the third DC voltages in the second channel region. In an embodiment, outside walls of the chamber include a plurality of connection pads electrically connected to each one of the two parallel filter electrodes, the two parallel detector electrodes, and the two parallel ion guidance electrodes. In an embodiment, the integrated oscillating field ion spectrometry device is a replaceable component of the oscillating field ion spectrometry system. In an embodiment, the oscillating field ion spectrometry system includes one or more shield grounds located on an outer surface of the detection segment. In an embodiment, the oscillating field ion spectrometry system includes a control system that is coupled to the second, third, and fourth DC voltage sources, the RF voltage source, and the detection segment, wherein, the control system is configured to control the second voltage source to adjust the second DC voltages and to adjust an amplitude or a frequency of the RF oscillating voltage of the RF voltage source, and configured to control the second DC voltages, the third DC voltages, and the fourth DC voltages.

According to some other embodiments of the disclosure, an integrated oscillating field ion spectrometry device includes a chamber divided into at least two connected segments including a filtering segment and a detection segment, wherein the detection segment is located downstream from the filtering segment in a direction of flow of a carrier gas. The filtering segment includes two parallel filter electrodes on opposing walls of a filtering segment channel region that are parallel to a direction of flow of the carrier gas. The two parallel filter electrodes are connected to a first DC voltage source to receive first DC voltages of opposite polarity, and are connected to a RF voltage source to receive an RF oscillating voltage. The detection segment includes two parallel detector electrodes on opposing walls of a detection segment channel region that are parallel to the direction of flow of the carrier gas. The two parallel detector electrodes are connected to a second DC voltage source to receive second DC voltages. The detection segment is configured to determine a number of positive and negative ions of a material vapor. Two parallel ion guidance electrodes are on opposing walls of the detection segment channel region. The ion guidance electrodes surround a periphery of the detector electrodes. The two parallel ion guidance electrodes are connected to a third DC voltage source to receive third DC voltages, and the two parallel ion guidance electrodes are configured to generate an electric field to guide ions to the two parallel detector electrodes. In an embodiment, the integrated oscillating field ion spectrometry device includes an ionization segment upstream from the filtering segment along the direction of flow of the carrier gas, wherein the ionization segment includes one or more inlets, an ionization segment channel region, and an ionization source in the ionization segment channel region selected from the group consisting of a cross-wire capacitive discharge ionizer, an ultraviolet ionizer, an electrospray ionizer, a radioactive ionizer, and combinations thereof. The ionization source is configured to ionize a material vapor. Two parallel ionization region electrodes are on opposing walls of the ionization segment channel region. The two parallel ionization region electrodes are connected to a fourth DC voltage source or to ground, and the two parallel ionization region electrodes are configured to prevent charging of dielectric surfaces in the ionization segment. In an embodiment, a height of the filtering segment channel region is less than a height of the ionization segment channel region, and a height of the detection segment channel region is greater than a height of the filtering segment channel region.

According to some other embodiments of the disclosure, a method of operating an integrated oscillating field ion spectrometry system including an integrated oscillating field ion spectrometry device, wherein the integrated oscillating field ion spectrometry device includes a chamber divided into at least three segments including: an ionization segment, a filtering segment, and a detection segment arranged in order in a direction of flow of a carrier gas, includes flowing, by the carrier gas, a mixture of the carrier gas and material vapor ions through the filtering segment and the detection segment. At least a portion of the material vapor in an ionization zone of the ionization segment is ionized to generate material vapor ions in the mixture. First DC voltages or ground are applied to two parallel ionization region electrodes on opposing walls of the ionization segment. At least a portion of ions other than the material vapor ions in the mixture are filtered by simultaneously applying an RF oscillating voltage and second DC voltages of opposite polarity to two parallel filter electrodes on opposing walls of the filtering segment. The material vapor ions are detected by applying third DC voltages to two parallel detector electrodes on opposing walls of the detection segment, and applying fourth DC voltages to two parallel ion guidance electrodes, wherein the two parallel ion guidance electrodes surround a periphery of the two parallel detector electrodes. In an embodiment, the method includes providing the carrier gas from a carrier gas source through a first opening of the ionization segment, wherein the carrier gas flows the material vapor to the ionization zone; and a modifier gas is provided through a second opening to the ionization segment. In an embodiment, the method includes mixing the carrier gas and the material vapor in the ionization segment. In an embodiment, the filtering at least a portion of ions other than the material vapor ions in the mixture includes discharging ions other than the material vapor ions by the two parallel detector electrodes on the opposing walls of the filtering segment. In an embodiment, the method includes separating positive and negative ions by simultaneously applying the RF oscillating voltage and applying the second DC voltages to the two parallel filter electrodes on the opposing walls of the filtering segment. In an embodiment, the method includes removing the integrated oscillating field ion spectrometry device from the system when a sensitivity of the device falls below a threshold value and installing a replacement integrated oscillating field ion spectrometry device in the system.

According to some embodiments of the disclosure, a method of operating an integrated oscillating field ion spectrometry system including an integrated oscillating field ion spectrometry device, wherein the integrated oscillating field ion spectrometry device includes a chamber divided into at least two segments including a filtering segment and a detection segment arranged in order, wherein the detection segment is located after the filtering segment in a direction of flow of a carrier gas, includes flowing, by the carrier gas, a mixture of the carrier gas and material vapor ions through the filtering segment and detection segment. At least a portion of ions other than the material vapor ions in the mixture are filtered by simultaneously applying an RF oscillating voltage and first DC voltages of opposite polarity to two parallel filter electrodes on opposing walls of the filtering segment. The material vapor ions are detected by applying second DC voltages to two parallel detector electrodes on opposing walls of the detection segment, and applying third DC voltages to two parallel ion guidance electrodes on the opposing walls of the detection segment, wherein the ion guidance electrodes surround a periphery of the detector electrodes. In an embodiment, the method includes providing a modifier gas to the mixture of the carrier gas and material vapor ions. In an embodiment, the filtering at least a portion of ions other than the material vapor ions in the mixture includes discharging ions other than the material vapor ions by the two parallel filter electrodes on the opposing walls of the filtering segment. In an embodiment, the method includes separating positive and negative ions by simultaneously applying the RF oscillating voltage and applying the first DC voltages to the two parallel filter electrodes on the opposing walls of the filtering segment. In an embodiment, the method includes removing the integrated oscillating field ion spectrometry device from the system when a sensitivity of the device falls below a threshold value and installing a replacement integrated oscillating field ion spectrometry device in the system.

### DETAILED DESCRIPTION

It is to be understood that the following disclosure provides many different embodiments, or examples, for implementing different features of the invention. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “being made of” may mean either “comprising” or “consisting of.” In the present disclosure, a phrase “one of A, B and C” means “A, B and/or C” (A, B, C, A and B, A and C, B and C, or A, B and C), and does not mean one element from A, one element from B and one element from C, unless otherwise described.

Identifying different materials with oscillating field ion spectrometry (OFIS) has become important because OFIS devices, compared to mass spectrometers, are smaller, portable, less expensive to procure and operate, less complex, use significantly less power, and do not require a high vacuum to operate. OFIS devices according to embodiments of the present disclosure provide greater detection sensitivity by increased ion transmission efficiency without compromising specificity. OFIS devices according to embodiments of the disclosure have improved performance, including a reduction in false negatives and false positives than FAIMS devices. OFIS devices according to embodiments of the disclosure avoid the reduction in sensitivity due to micro-deposits and surface charging in the analytical channel that occurs in FAIMS devices. Fabrication and testing of OFIS devices according embodiments of the disclosure is simpler and less expensive than FAIMS devices. In addition, OFIS devices according to embodiments of the disclosure have an expanded operational temperature range than FAIMS devices. Further, OFIS devices according to embodiments of the disclosure are replaceable. When the sensitivity of the OFIS system falls below a threshold level, the OFIS device can be quickly and economically replaced. Ion transfer efficiency losses, gas path leaks, and higher assembly costs of FAIMS devices are reduced or eliminated in OFIS devices according to embodiments of the disclosure. OFIS devices according to embodiments of the disclosure provide ultra-trace (e.g.—less than 1 ppm) detection and identification of chemical vapors of interest.

In an integrated OFIS device, first, second, and third segments (or regions) are arranged in a line next to each other. The first region is an ionization segment where the material vapor that is being identified along with a carrier gas flows through the ionization segment. The ionization segment includes a plasma generating region that generates plasma from the gas that flows through the ionization segment. The plasma generating region generates ions from the material vapor and the carrier gas. Other ions may be generated in the plasma generating region including modifier ions, fragmented ions, ambient ions, contaminant ions, and ions of additional materials that may be present in the sample. In some embodiments, a portion of the material vapor and a portion of the carrier gas is ionized and a remaining portion of the sampled material and the carrier gas is not ionized. The second region is a filtering segment that is located next to the ionization segment along a direction of flow of the carrier gas. In some embodiments, the carrier gas carries the ions from the ionization segment to the filtering segment. The third region is a detection segment that is located next to the filtering segment along a direction of the carrier gas flow. In some embodiments, the carrier gas carries the ions from the filtering segment to the detection segment. In some embodiments, all the gases and vapors, including the carrier gas, a modifier gas, and the material vapors exit the OFIS device from the detection segment. In some embodiments, the first, second, and third segments make up a single channel through the ionization segment, the filtering segment, and the detection segment.

The filtering segment includes two parallel electrodes on opposing walls of the filtering segment that are parallel to the direction of the flow the carrier gas, e.g., on top and bottom walls or on opposing sidewalls. The two electrodes are connected to a voltage source that provides opposite polarity DC voltages to the two electrodes. The two electrodes are additionally connected to a radio frequency (RF) voltage source that provides an RF oscillating voltage in addition to the DC voltage to the two electrodes. When the carrier gas carries the ions from the material vapor between the two electrodes, the positive and negative ions experience forces by the electric fields generated by the DC and RF voltages between the two electrodes and move in opposing directions as the RF voltage changes from positive to negative. In some embodiments, the combination of the opposite polarity DC voltages and the RF oscillating voltage causes unwanted ions, such as the carrier gas ions or ions of materials other than the ions of the material vapor, to reach the two parallel electrodes of the filtering segment and get discharged while the carrier gas and material vapor ions are passing by the parallel electrodes. Thus, some of the ions are removed, e.g., filtered from the flowing carrier gas to provide filtered material vapor. In some embodiments, the ions of the material vapor, are undischarged as they flow from the filtering segment to the detection segment. In some embodiments, the unwanted ions include the ions of contaminants that have entered the ionization segment or the ions of the material forming the ionization segment.

The detection segment includes two parallel electrodes on opposing walls of the detection segment that are parallel to the direction of the flow of the carrier gas, e.g., on top and bottom walls or on opposing sidewalls, similar to the parallel electrodes of the filtering segment. The two electrodes are connected to a voltage source that provides DC voltages to the two electrodes of the detection segment. In some embodiments, DC voltages of opposite polarity are applied to the opposing parallel electrodes. The two parallel electrodes of the detection segment are additionally connected to a detection system that detects, e.g., registers or counts, the number of ions that impact the two parallel electrodes of the detection segment and get discharged. In some embodiments, the detection system is a charge detector. In some embodiments, the positive ions are discharged by one of the two parallel electrodes and the negative ions are discharged by the other electrode of the two parallel electrodes of the detection segment and the detection system detects the number of positive and negative ions, e.g., based on the number of ions registered and discharged by the two electrodes. Ions of additional unidentified materials may be detected. The detection information of the unidentified materials may be stored in a memory of the OFIS system for subsequent identification and analysis if desired.

In some embodiments, the DC voltages of the two electrodes of the detection segment, the DC voltages of the two electrodes of the filtering segment, the RF voltages and the RF frequency applied between the two electrodes of the filtering segment are adjusted based on the mobility of the ions of the material vapor and the mobility of the unwanted ions, such as the carrier gas ions. The RF voltage and the DC voltage of the filtering segment are selected to optimize sensitivity and selectivity of the OFIS device. For example, higher RF voltage provides increased separation of the ions, thereby increasing selectivity. However, increasing the RF voltage may reduce the sensitivity. The adjustment of the RF and DC voltages cause a portion of the unwanted ions to be discharged, e.g., to be removed, in the filtering segment and a remaining portion of unwanted ions along with wanted ions, unknown ions, and neutrals to pass by the parallel electrodes of the detection segment. As discussed above, in filtering the unwanted ions, the ions are discharged in the filtering segment and, thus, are not detected by the detection system in the detection segment, although, the discharged ions are carried by the carrier gas.

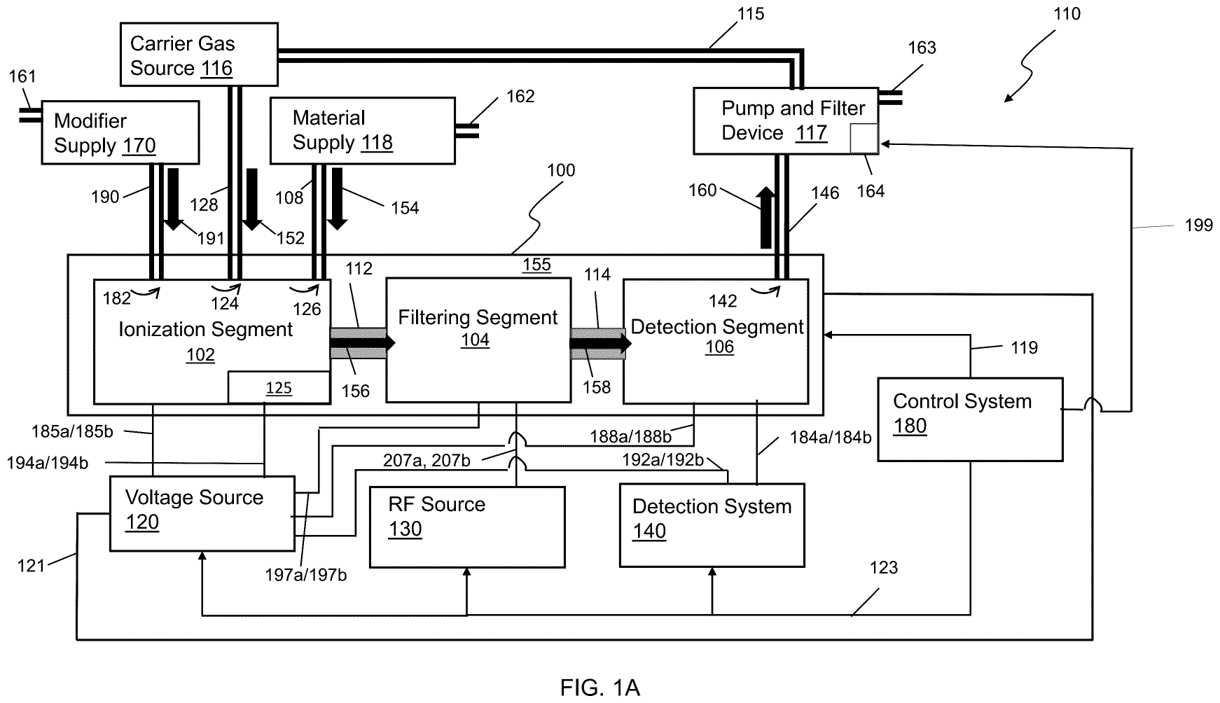

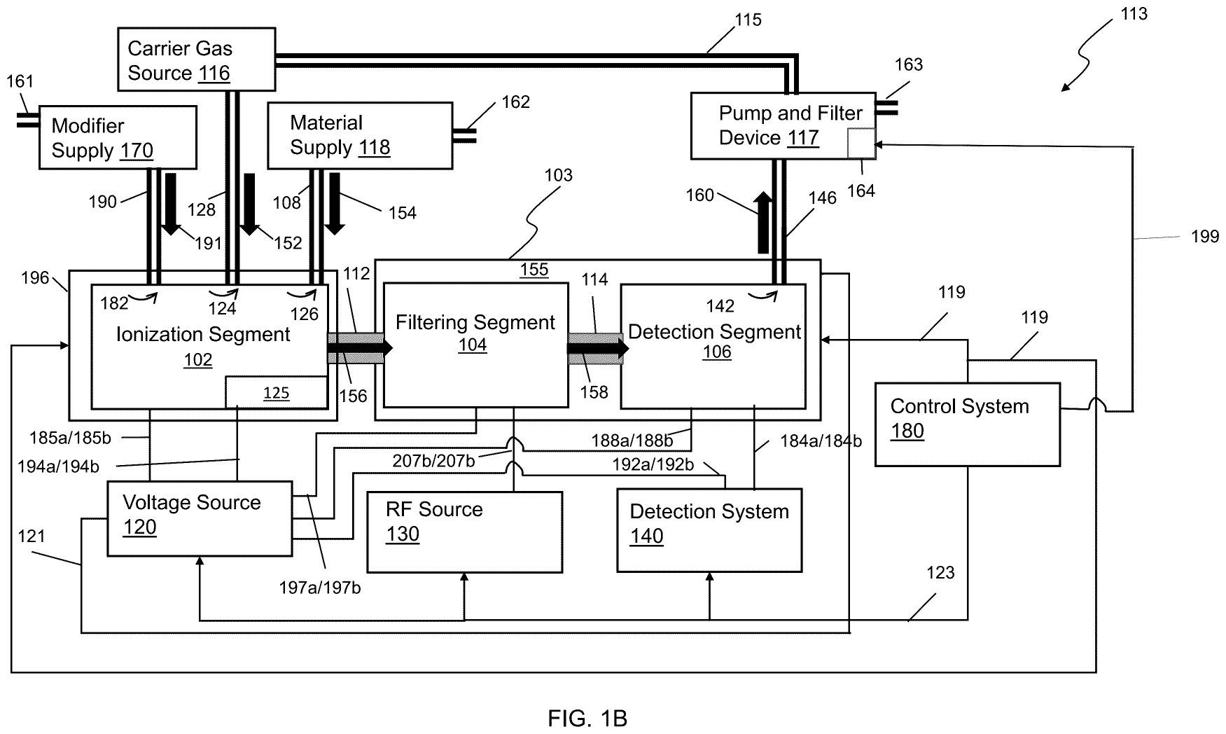

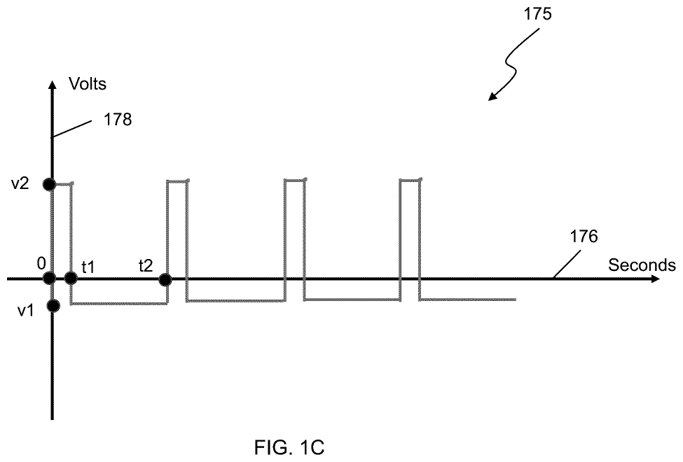

FIG. 1A shows an oscillating field ion spectrometry system 110 including an OFIS device (or sensor) 100 and periphery apparatuses of the OFIS system. The OFIS device (or sensor) 100 includes a chamber 155 that has three segments, an ionization segment 102, a filtering segment 104, and a detection segment 106 in some embodiments. The ionization segment 102 is connected to the filtering segment 104 through an interface 112. The ionization segment 102 includes a first opening 124 that is connected to a pipe 128. A carrier gas flow 152 enters the ionization segment 102 via the pipe 128 from a carrier gas source 116 outside the OFIS device 100. In some embodiments, the carrier gas source 116 includes nitrogen, argon, air, or any suitable gas.

As shown, the ionization segment 102 also includes a second opening 126 that is connected to a pipe 108 leading to a material vapor flow 154. The material vapor flow enters the ionization segment 102 via the pipe 108 from a material supply 118 outside the OFIS device 100. In some embodiments, the material supply 118 includes samples of one or more material vapors, including biomarkers of infection and disease, drugs, dangerous chemicals, biological agents, breath, or polluted air. The material vapor flow 154 may include substantially only the material vapor being sampled or the material vapor being sampled may be mixed with a carrier gas, such as air, to provide the material vapor flow 154. In some embodiments, the material supply 118 receives the material through a pipe 162. In some embodiments, a flow of nitrogen and/or air that includes the material being sampled enters the material supply 118 through the pipe 162 and generates the material vapor flow 154. In some embodiments, the material is in gas form, liquid form, or solid form inside the material supply 118. The flow of nitrogen and/or air enters the material supply 118 through the pipe 162, mixes with the material, and generates the material vapor flow 154. In some embodiments, the material being sampled is introduced intermittently into ionization segment 102. In some embodiments, the material being sampled is breath.

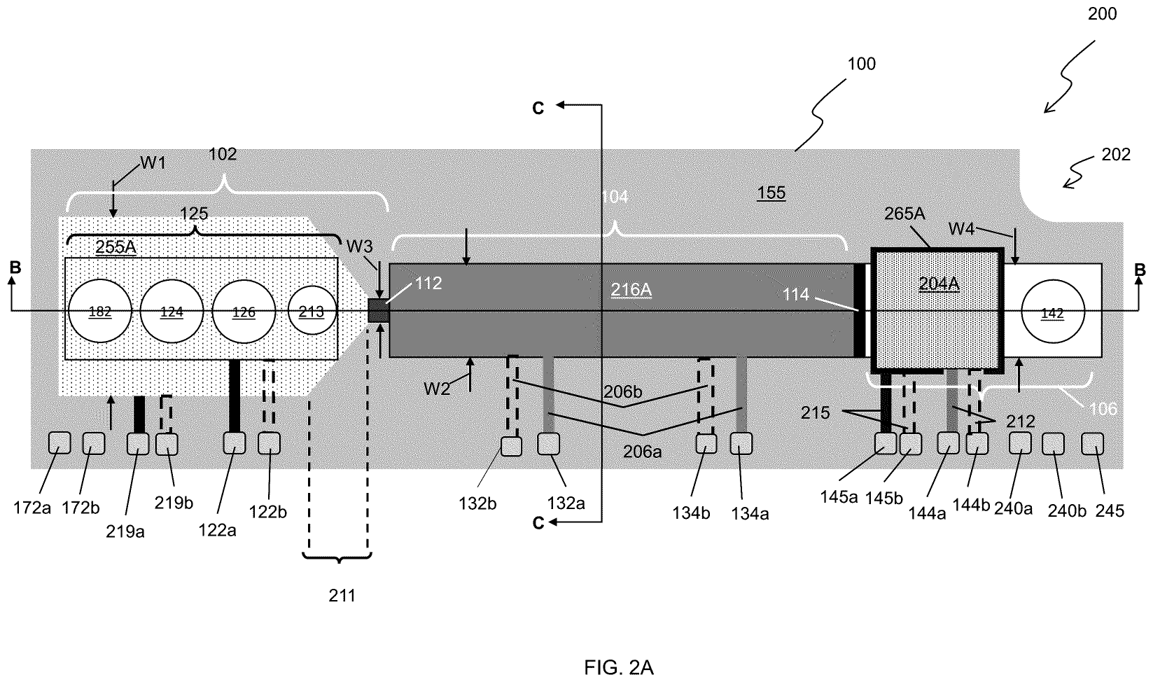

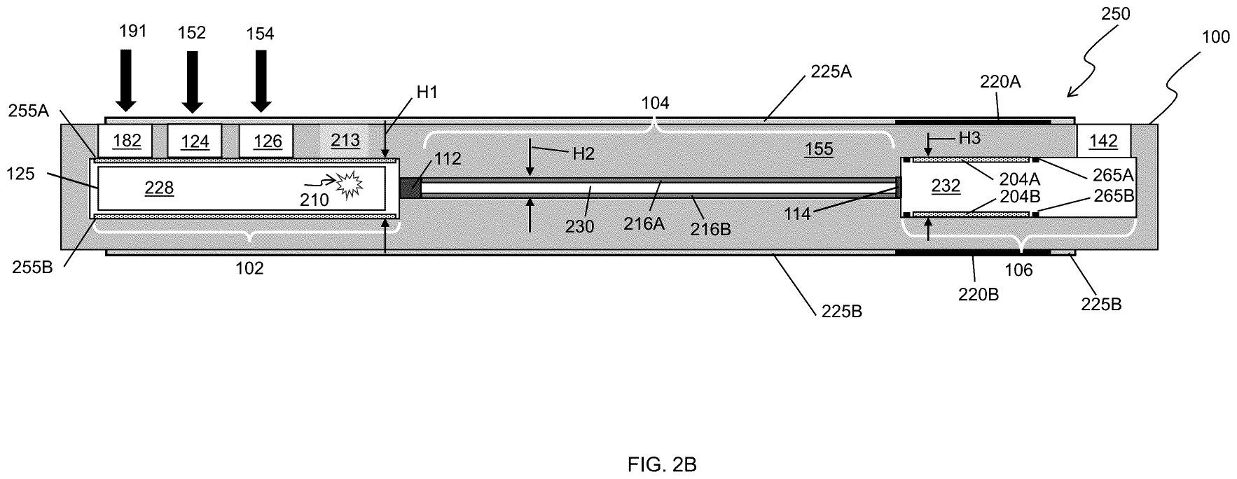

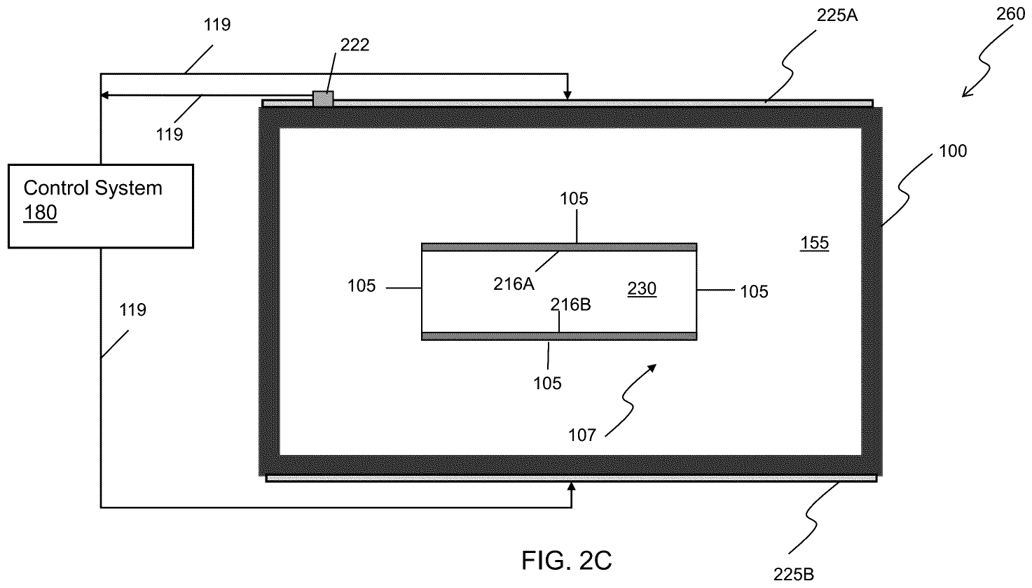

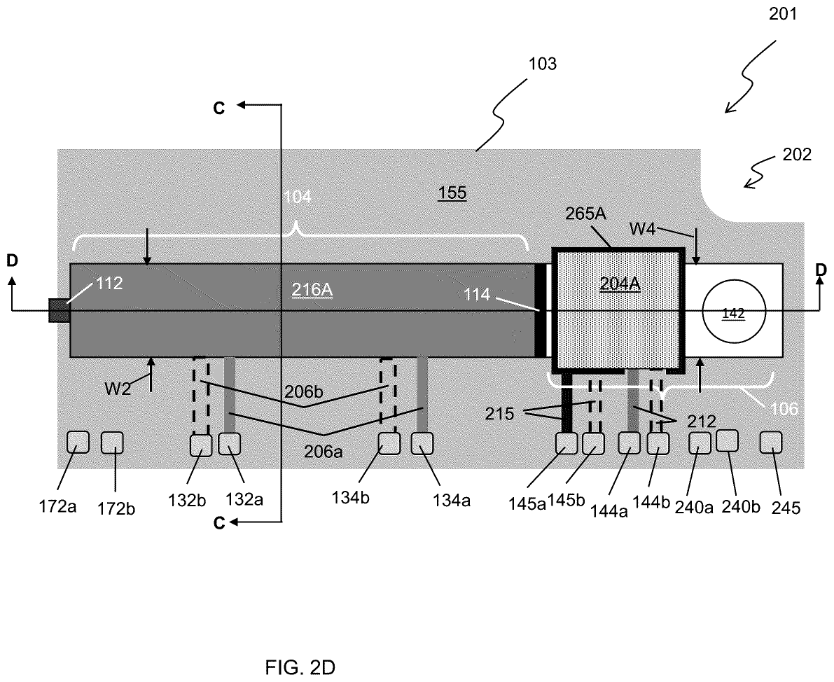

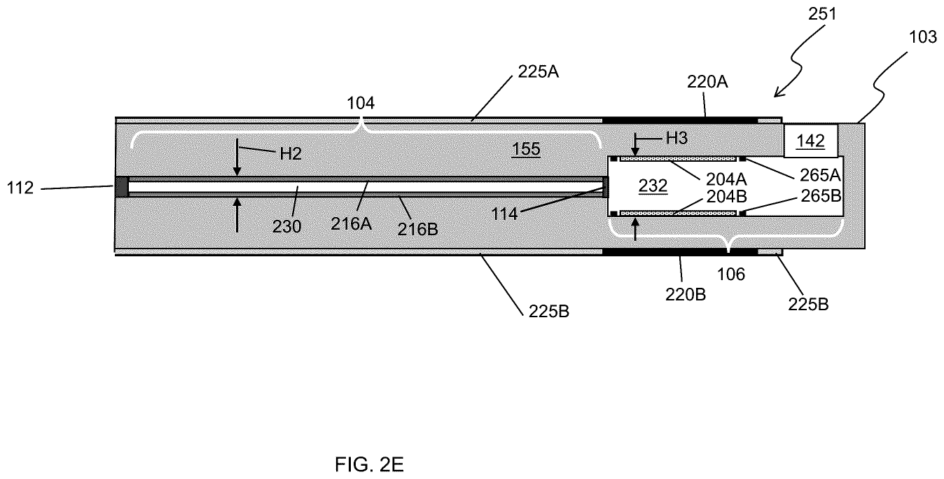

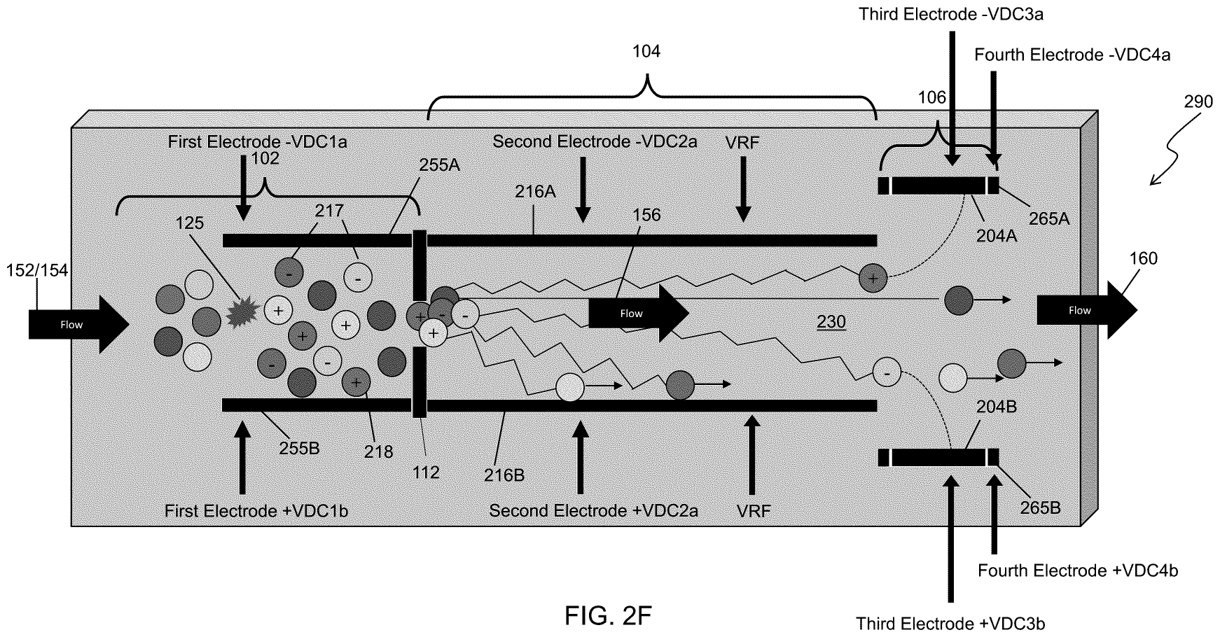

The material vapor flow 154 and the carrier gas flow 152 are mixed inside the ionization segment, the mixture is ionized by an ionizing tool 125, e.g., an ionization source, and the mixture that includes the ions of the sampled material flows out of the ionization segment 102 through the interface 112 as a gas flow 156. The ionization segment is described in more details with respect to FIGS. 2A and 2B. In some embodiments, the gas flow 156 is a combination of the sampled gas flow 154 and the carrier gas flow 152 that is at least partially ionized.

In some embodiments, the ionization segment 102 includes an additional third opening 182 that is connected to a pipe 190. A modifier gas flow 191 enters the ionization segment 102, through the opening 182 and via the pipe 190, from a modifier supply 170 outside the ionization segment 102 that is outside the OFIS device 100. In some embodiments, a flow of nitrogen and/or air that includes the modifiers enters the modifier supply 170 through the pipe 161 and generates, e.g., creates, the modifier gas flow 191. In some embodiments, the modifier is in gas form, liquid form, or solid form inside the modifier supply 170. The flow of nitrogen and/or air that enters the modifier supply 170 through the pipe 161, mixes with the modifier, and generates the modifier gas flow 191. In some embodiments, the modifier includes a dopant. In some embodiments, the modifier gas flow 191 changes the ion chemistry such that it enhances the ionization of one or more atoms or compounds and/or suppresses the ionization of one or more atoms or compounds. In some embodiments, the modifier is selected such that the modifier is not ionized in the ionization segment 102. In some embodiments, the modifier is a suitable solvent. The modifier may include but is not limited to one or more selected from the group consisting of water, acetonitrile, acetone, ethyl acetate, propyl acetate, n-butyl acetate, methanol, ethanol, 1-propanol, 2-propanol, methylene chloride, and cyclohexane. The modifier may alter the ions, including changing the structure of the ions. In some embodiments, the modifier may change the molecular weight of the sampled material by either causing the sampled material to cluster (i.e.—increasing the molecular weight) or fragmenting the sampled material (i.e.—decreasing the molecular weight). In some embodiments, a counter flow enters the ionization segment 102 through a fourth opening (not shown) and exits through a fifth opening (not shown). In some embodiments, the counter flow flows in the opposite direction of the carrier gas, sample, and modifier flows and helps suppress chemical noise. The detection of ions is described with respect to FIG. 2F. In other embodiments, no modifier is used and the ionization segment 102 does not include the modifier entry port.

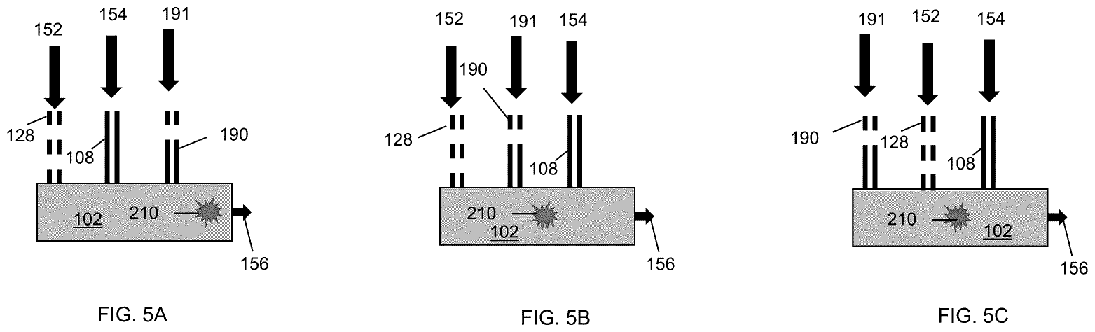

In some embodiments, in addition to the material vapor, ions of the carrier gas flow 152 and the modifier flow 191 are also ionized by the ionizing tool 125 and carrier gas ions and modifier ions are generated. In some embodiments, the carrier gas or modifier are ionized in the ionization zone 210 of the ionizing tool 125 (see FIG. 2B) and then the ionized carrier gas or modifier ionizes the material vapor. Thus, the gas flow 156 may include the ions of the material vapor, the carrier gas, and modifier (see configurations in FIGS. 5A, 5B, and 5C). In some embodiments, the carrier gas ions or modifier are undesired. Thus, the oscillating field ion spectrometry system 110 and the OFIS device 100 are designed to prevent the carrier gas and modifier ions from interfering with identification of the type of the material vapor and determination of the amount of the material vapor. As shown, two or more voltages are applied to the ionization segment 102 from a voltage source 120 via two or more electrical connection lines, e.g., connection lines 194a, 194b. The two or more voltages are applied to the ionizing tool 125 to ionize the sampled material and/or the carrier gas. In some embodiments, two ionization region electrodes 255A, 255B are disposed on opposing sidewalls of the ionization segment 102. The two ionization region electrodes 255A, 255B are parallel to each other and extend along a direction of flow of the carrier gas and material vapor. In some embodiments, the parallel ionization region electrodes 255A, 255B are connected to a DC voltage source 120 via two or more connection lines 185a, 185b. In some embodiments, the DC voltage source 120 includes a plurality of DC voltage sources (e.g.—a first DC voltage source, a second DC voltage source, a third DC voltage source, etc.) where each DC voltage source provides DC voltages to a different pair of opposing electrodes (e.g.—the ionization region electrodes 255A, 255B, the filter electrodes 216A, 216B, the detection electrodes 204A, 204B, the guidance electrodes 265A, 265B). In other embodiments, the ionization region electrodes 255A, 255B are connected to ground. The ionization region electrodes prevent charging of dielectric surfaces in the ionization segment 102.

In some embodiments, other material, such as a contaminant exists in the ionization segment. In such embodiments, the contaminant material may also be ionized. In some embodiments, outgassing in the OFIS device produces contaminants. The contaminants may affect the sensitivity and the results provided by the detection system 140. Thus, in some embodiments, the carrier gas source 116, the material supply 118, the pipes 161, 162, 128, and 108, and the components in the ionization segment 102 are designed and selected to prevent outgassing. In some embodiments, the carrier gas flow is between about 50 milliliter (ml) per minute (min) to about 500 ml/min. In some embodiments, the carrier gas flow is between about 100 ml/min to about 150 ml/min. In some embodiments, the carrier gas is air, nitrogen, helium, hydrogen, any suitable gas, or a combination of two or more of the gasses.

As shown in FIG. 1A, the OFIS device 100 includes the filtering segment 104. The filtering segment 104 receives the gas flow 156 that includes the ions of the material vapor through the interface 112. In some embodiments, ions of the carrier gas or modifier and the material vapor are generated by the ionizing tool 125 and, thus, the ions of the carrier/modifier and the material vapor exist in the gas flow 156. An electric field is generated inside the filtering segment 104 by applying a voltage, via two or more electrical connection lines, e.g., connection lines 197a, 197b and 207a, 207b, between the electrodes (e.g., electrodes 216A and 216B of FIG. 2B) of the filtering segment 104 and the DC voltage source 120 and the RF source 130. In some embodiments, the DC voltage source 120 and the RF source 130 share common connection lines to the electrodes. Thus, the RF source generates an RF voltage between the electrodes 216A and 216B, and the DC voltage source 120 additionally generates a DC voltage between the electrodes 216A and 216B. The electric field direction and intensity is adjusted to remove undesired ions for the application from gas flow mixture 156. Thus, ions other than specific ions of the material vapor are discharged by contacting the electrodes of the filtering segment. In some embodiments, while the carrier gas ions and modifier ions are discharged in the filtering segment 104, some carrier gas ions, modifier ions, and neutral atoms or molecules may remain in the carrier gas flow 156 as they pass through the detection segment 106. The filtering segment 104 is connected to the detection segment 106 through an interface 114. In some embodiments, the gas flow 158 that is a continuation of the gas flow 156 flows through the interface 114 between the filtering segment 104 and the detection segment 106. In some embodiments, a portion of the ions in the gas flow 156 is discharged in the filtering segment 104 and the gas flow 158 is produced. The filtering segment 104 is described in more detail with respect to FIGS. 2A, 2B, and 2C.

As shown in FIG. 1A, the OFIS device 100 includes the detection segment 106. The detection segment 106 receives the gas flow 158 that includes the ions of the material vapor through the interface 114. An electric field is generated inside the detection segment 106 by applying an electric voltage, via two or more electrical connection lines, e.g., connection lines 192a, 192b, between the voltage source 120 and the detector electrodes (e.g., detector electrodes 204A, 204B of FIG. 2B that are used for detecting the ions in the detection segment 106). The electrical connection lines 192a, 192b are connected to a detection system 140 disposed between the voltage source 120 and the detection segment 106. Two or more electrical connection lines 184a, 184b connect the detection system 140 to connection pads 144a, 144b of the detector electrodes 204A, 204B.

The electric field direction and intensity is adjusted such that the ions of the sampled material in the gas flow 158 are discharged by the electrodes 204A, 204B of the detection segment 106. The detector electrodes 204A, 204B of the detection segment 106 are connected via two or more electrical connection lines 184a, 184b to the detection system 140. In some embodiments, the detection system 140 is a charge detector that determines an amount of charge absorbed by the electrodes. Based on the amount of charge absorbed by the electrodes of the detection system 140, the detection system determines an amount of ions that are discharged by the electrodes of the detection segment 106 (e.g.—quantity of ions/time, current).

In some embodiments, two ion guidance electrodes 265A, 265B are disposed parallel to each other on opposing sidewalls of the detection segment 106. The ion guidance electrodes 265A, 265B surround a periphery of the detector electrodes 204A, 204B. In some embodiments, the ion guidance electrodes 265A, 265B are connected to a DC voltage source 120 by two or more connection lines 188a, 188b via corresponding connection pads 145a, 145b. The ion guidance electrodes 265A, 265B increase the efficiency of the detection segment 106 by directing the material vapor ions to the detector electrodes 204A, 204B. The ion guidance electrodes 265A, 265B also prevent leakage current from the filtering segment 104 from impacting the detector electrodes 204A, 204B.

In some embodiments, the DC voltage source 120 includes a plurality of DC voltage sources (e.g.—a first DC voltage source, a second DC voltage source, a third DC voltage source, a fourth DC voltage source, etc.) where each DC voltage source provides DC voltages to a different pair of opposing electrodes (e.g.—the ionization region electrodes 255A, 255B, the filter electrodes 216A, 216B, the detector electrodes 204A, 204B, the ion guidance electrodes 265A, 265B).

The detection segment 106 is described in more detail with respect to FIGS. 2A and 2B. The connection lines described above, including connection lines 184a, 184b, 185a, 185b, 188a, 188b, 192a, 192b, 194a, 194b, 197a, 197b, 207a, and 207b may include more than one line.

As explained herein, the RF voltage and the DC voltage of the filtering segment may be selected to optimize the sensitivity and selectivity of the OFIS device. In some embodiments, the flow of the ions depends on the charge of the ion and the mobility of the ions. The detection segment 106 further includes an opening 142 connected to a pipe 146 and an exhaust gas flow 160 exits the detection segment 106 via the pipe 146 into a pump and filter device 117 outside the OFIS device 100. The pump and filter device 117 extracts the exhaust gas flow 160 via a pump of the pump and filter device 117 and filters the exhaust gas flow 160 to remove the material vapor of the material vapor flow 154 and other residues from the exhaust gas flow 160 and return remaining carrier gas of the carrier gas flow 152, via a pipe 115, to the carrier gas source 116. In some embodiments, the pump and filter device 117 includes multiple stages of a filter and/or pump followed by another stage of a filter and/or pump and the pump and filter device 117 cleans the exhaust gas flow 160 in multiple stages. In some embodiments, the pump and filter device 117 includes one pump and multiple filters stacked one after the other and the pump and filter device 117 cleans the exhaust gas flow 160 using the multiple filters. In some embodiments, the pump and filter device includes a pressure sensor 164 to monitor the pressure in the OFIS device. A breather element/exhaust port 163 may be provided in the pump and filter device to release pressure from the OFIS system to maintain a constant pressure. Maintaining a consistent pressure through the OFIS device provides consistent, reproduceable results. In some embodiments, the components in the pump and filter device 117 are arranged in the following order: breather element/exhaust port 163, filter, pump, filter, pressure sensor, along the direction of the exhaust gas flow 160.

In some embodiments, the exhaust gas flow 160 also includes the modifier gas of the modifier gas flow 191 and pump and filter device 117 filters the modifier gas. In some embodiments, each filter of the pump and filter device 117 extracts one of the material vapor, modifier gas, or an impurity and the collection of the filters of the pump and filter device 117 cleans the exhaust gas flow 160.

The oscillating field ion spectrometry system 110 also includes a control system 180 that is coupled to, through a control line 123, and controls the voltage source 120, the RF source 130, and the detection system 140. Based on the amount of discharged ions of the material vapor detected by the detection system 140, the control system 180 may adjust the output voltages of the voltage source 120 applied to the filtering segment 104 and the detection segment 106. The control system 180 may also adjust the frequency and amplitude of the output RF voltage applied to the filtering segment 104 based on the mobility of the carrier gas ions and the ions of the material vapor. The control system 180 may independently control the DC voltages applied to each of the ionization region electrodes 255A, 255B, the filter electrodes 216A, 216B, the detector electrodes 204A, 204B, and the ion guidance electrodes 265A, 265B. In addition, the control system 180 is connected, via a control line 119, to a body of the chamber 155 to control a temperature of the chamber 155 via temperature monitoring using thermistor 222. The control system 180 may further independently control the pump in the pump and filter device 117, monitor the pressure sensed by the pressure sensor 164, and/or open and close the breather element/exhaust port 163 to control the pressure in the OFIS system by feedback control, via a control line 199.

In some embodiments, the material of the pipes 190, 162, 161, 128, 115, 146, 108, or 163 is made of, but is not limited to, one of stainless steel, silcosteel, polytetrafluoroethylene (PTFE), polyetheretherketone (PEEK), liquid crystalline polymer (LCP), fluorocarbon rubber (e.g. Viton®), or a ceramic, such as alumina.

In some embodiments, the OFIS device or sensor 100 includes one or more outer surface ground shields 220A, 220B over the outer wall of the chamber 155. The one or more ground shields 220A, 220B are described with respect to FIG. 2B. The voltage source 120 may be connected, via at least one connection line 121, to the one or more ground shields 220A, 220B. The one or more ground shields 220A, 220B are described with respect to FIG. 2B. Also, one or more surface heaters 225A, 225B are arranged, e.g., mounted over, and are connected to the outer wall of the chamber 155 and the control system 180 is connected to the outer surface heaters 225A, 225B via the control line 119 in some embodiments. The one or more outer surface heaters 225A, 225B are described with respect to FIG. 2C. In some embodiments, a thermistor 222 and one or more surface heaters (not shown) are also mounted over and connected to the outer walls of the ionization device 196 and the control system 180 is connected to the thermistor 222 and outer surface heaters via the control line 119. In the OFIS system 110, the three segment OFIS device or sensor 100 is disposable, and can be replaced by a replacement three segment OFIS device as needed.

FIG. 1B shows an OFIS system 113 that includes a two segment OFIS device 103 and periphery apparatuses of the OFIS system 113. The difference between the OFIS system 113 and the OFIS system 110 is that in the OFIS system 113, the ionization segment 102 is not included in the two segment OFIS device or sensor 103. The two segment OFIS device 103 includes the filtering segment 104 and the detection segment 106. As shown in FIG. 1B, the ionization segment 102 and the ionizing tool 125 are included in a separate ionization device 196 and the ionization segment 102 of the ionization device 196 is connected to the filtering segment 104 of the OFIS device 103 via an interface 112. The gas flow 156 is transferred between the ionization segment 102 of the ionization device 196 and the filtering segment 104 of the OFIS device 103 through the interface 112. In the OFIS system 113 including the two segment OFIS device 103, the two segment OFIS device 103 is disposable, and can be replaced by a replacement two segment OFIS device independent of the ionization segment as needed.

FIG. 1C is a waveform of a periodic strong asymmetric RF voltage. FIG. 1C shows several periods of the RF voltage with a graph 175 displayed on voltage 178 and time 176 axes. The RF voltage is applied to the electrodes of the filtering segment 104. The electrodes 216A, 216B of the filtering segment 104 are shown in FIG. 2B. As shown, the voltage from electrode 216A to electrode 216B changes between a positive voltage v2 and a negative voltage v1, such that the positive voltage v2 is applied for a time period from time zero to time t1 and the negative voltage v1 is applied for a time period from time t1 to time t2. In some embodiments, the voltages v1 and v2 and the times t1 and t2 are selected such that an area in one period of the graph 175 having the voltage v2 is equal to the area having the voltage v1 and the total net area under a period of the graph 175 for voltages v1 and v2 is zero. In some embodiments, the difference between v2 and v1 (v2−v1), the amplitude of the RF voltage, is between about 250 volts and about 2000 volts and the frequency of the RF voltage is between about 1 MHz and about 2 MHz. In other embodiments, the amplitude of the RF voltage is between about 800 volts and 1500 volts. In some embodiments, the amplitude of the RF voltage is equal and opposite on the opposing electrodes. For example, the voltage may be +750 V on one electrode and −750 V on the opposing electrode, for a total voltage difference of 1500 V. In some embodiments, the time difference between t2 and t1 (t2−t1) is about 3 to 5 times the time period t1 (between t1 and the time zero). In some embodiments, v2 is 1600 volts and v1 is −400 volts.

FIGS. 2A, 2B, and 2C show a schematic top plan view of a three segment integrated OFIS device, a cross sectional view along line B-B, and a cross sectional view along line C-C, according to an embodiment of the present disclosure. FIG. 2A shows a top plan view 200 of the integrated OFIS device 100 of FIG. 1A and shows the ionization segment 102, the filtering segment 104, and the detection segment 106.

The ionization segment 102 includes a first opening 124 and a second opening 126. In some embodiments, the ionization segment 102 includes a viewing window 213 arranged over an ionization zone 210 of the ionizing tool 125 of the ionization segment 102 so that a viewer or sensor may view the ionization zone 210 from outside the OFIS device 100. In some embodiments, the ionizing tool 125 of the ionization segment 102 is an ionization source that generates carrier gas ions, modifier gas ions, and sampled gas ions. In some embodiments, the ionization source produces a plasma discharge environment in the ionization zone 210. In an example, the ionization source is a plasma source, such as a cross-wire capacitive discharge device that may include biased electrodes (not shown) that are connected to the voltage source 120 through connection pads 122a, 122b and via the connection lines 194a, 194b (which may include additional connection lines). The ionization segment 102 includes a pair of parallel ionization region electrodes 255A, 255B on opposing sidewalls of the ionization segment channel 228.

In some embodiments, a width W1 of the ionization segment channel 228 is between about 0.1 inches and about 0.3 inches and in other embodiments, the width W1 is between about 0.15 inches and about 0.25 inches. As shown, the ionization segment 102 is connected to the filtering segment 104 through an interface 112. The interface 112 has a width W3 about 5 to 10 times smaller than the width W1. The ionization segment 102 has a transition zone 211 that is tapered (e.g., linearly tapered) towards the interface 112. In some embodiments, a length of the transition zone 211 is between about one third to one fourth of the length of the ionization segment 102 that is, including the transition zone 211, between about 0.25 inches and about 0.35 inches. As shown in FIG. 2B, the carrier gas flow 152 and/or the sampled gas flow 154 flow through the ionization segment channel 228. In some embodiments, the ionization zone 210 is part of the channel 228. The width of the channel 228 becomes narrower at the transition zone 211. In some embodiments, connection pads 219a, 219b are used to connect the voltage source 120 to the ionization region electrodes 255A, 255B. In some embodiments, ionized samples produced in another ionization source enter the ionization segment through the opening 126. In some embodiments, the another ionization source is a radioactive ionization source. In some embodiments, the control system 180 controls the operation of the ionization segment 102 and the ionizing tool 125.

The filtering segment 104 is also shown in FIG. 2A. As discussed herein, the filtering segment 104 has two parallel electrodes 216A, 216B. FIG. 2A shows the top electrode 216A, which is parallel to the bottom electrode 216B (shown in FIG. 2B) located below the top electrode 216A. The top and bottom electrodes 216A, 216B are connected through the connection lines 206a, 206b and connection pads 132a, 132b, 134a, 134b on a body of the chamber 155 of the OFIS device 100 to the connection lines 197a, 197b, 207a, 207b that are connected to the DC voltage source 120 and the RF source 130 (e.g., an RF voltage source), respectively. The filtering segment 104 is connected through the interface 114 to the detection segment 106.

The filtering segment 104 has a width W2, which ranges from about 0.05 inches to about 0.15 inches in some embodiments, and in other embodiments, the width W2 is between about 0.075 inches and about 0.12 inches. In some embodiments, the width of the filtering segment W2 is the same as the width W1 of the ionization segment channel 228, in other embodiments, W1 and W2 are different. In some embodiments, the interface 114 has the same width as the width of the filtering segment 104. In some embodiments, because of the narrowing of the transition zone 211 and the interface 112, the gas flow 156 enters the filtering segment 104 as a jet entry. In some embodiments, the pair of parallel filter electrodes 216A, 216B and the pair of parallel detector electrodes 204A, 204B are parallel to each other. In some embodiments, the transition zone 211 of the ionization segment 102 is tapered to prevent eddies and produce the jet entry. The jet entry is facilitated by a change in the height H1 of the ionization segment channel 228 to the height H2 of the filtering segment channel 230 (see FIG. 2B). In some embodiments, the height of the channel is reduced by 5X to 7X, while the channel width is constant, transitioning from the ionization segment 102 to the filtering segment 104. In some embodiments, the change in height of the ionization segment channel 228 to the filtering segment channel 230 is a step down change, not a gradual change.

The detection segment 106 is also shown in FIG. 2A. As discussed herein, the detection segment 106 has two parallel electrodes. FIG. 2A shows the top detector electrode 204A which is parallel to the bottom detector electrode 204B (shown in FIG. 2B) located below the top detector electrode 204A. The top and bottom detector electrodes 204A, 204B are connected through the connection lines 212 and connection pads 144a, 144b on the body of the chamber 155 of the OFIS device 100 to the connection lines 184a, 184b that are connected to the detection system 140, which is connected to the voltage source 120 via two or more electrical connection lines 192a, 192b. In some embodiments, two ion guidance electrodes 265A, 265B are disposed parallel to each other on opposing sidewalls of the detection segment 106. The ion guidance electrodes 265A, 265B surround a periphery of the detector electrodes 204A, 204B. In some embodiments, the ion guidance electrodes 265A, 265B are connected to a DC voltage source 120 via two or more connection lines 188a, 188b.

In some embodiments, the detection segment 106 has a width W4. In some embodiments, the width W4 of the detection segment 106 is the same as the width W2 of the filtering segment 104, in other embodiments, the widths are different. In some embodiments, the width W2 of the filtering segment 104 and the width W4 of the detection segment 106 are half the width W1 of the ionization segment 102.

In some embodiments, a length of the filtering segment 104 and the detection segment 106 together ranges from about 0.6 inches to about 0.75 inches. The detection segment 106 includes an opening 142 and ground shields 220A, 220B on the outside surface of the OFIS device 100. The top ground shield 220A is parallel with a bottom ground shield 220B (shown in FIG. 2B). The top and bottom ground shields 220A, 220B are connected through the connection pads 240a, 240b on the body of the chamber 155 of the OFIS device 100 to the one or more connection line(s) 121 connected to the voltage source 120. In some embodiments, the top and bottom ground shields 220A, 220B are connected to the ground. Connection pads 240a, 240b on the outside surface of the body of the chamber 155 of the OFIS device 100 are described with respect to FIGS. 2A and 2D. In some embodiments, the body of the chamber 155 of the OFIS device 100 has an indentation 202 to show the orientation of the segments of the replaceable OFIS device 100 in the system 110. In some embodiments, the indentation 202 defines an orientation of the body of the chamber 155 when replacing the integrated OFIS device 100.

FIG. 2B is a schematic cross sectional view 250 along a length of the integrated OFIS device 100 of FIG. 2A along line B-B showing the ionization segment 102, the filtering segment 104, and the detection segment 106. As shown, the ionization segment 102 includes the first opening 124, the second opening 126, and the viewing window 213 arranged over the ionization zone 210 of the ionization segment 102. The ionization segment 102 is connected through the interface 112 to the filtering segment 104. In some embodiments, a height H1 of the ionization segment 102 ranges from about 0.04 inches to about 0.25 inches and in other embodiments the height H1 is between about 0.08 inches and about 0.2 inches. As shown in FIG. 2B, the filtering segment 104 has two parallel electrodes 216A, 216B that are respectively at the top and bottom of the filtering segment 104. The filtering segment 104 is connected through the interface 114 to the detection segment 106. In some embodiments, the filtering segment 104 has a height H2, which ranges from about 0.015 inches to about 0.035 inches and in other embodiments, the height H2 is between about 0.02 inches and 0.027 inches. In some embodiments, the heights of the interface 112 and the interface 114 are the same height as the height H2 of the filtering segment 104.

FIG. 2B also shows the detection segment 106. As discussed herein, the detection segment 106 has two parallel detector electrodes 204A, 204B. As shown, the top detector electrode 204A is parallel to the bottom detector electrode 204B. In some embodiments, the detection segment 106 has a height H3, which ranges from about 0.04 inches to about 0.2 inches, and in other embodiments, H3 is between about 0.08 inches and about 0.1 inches. In some embodiments, the height H3 is the same as the height H1. The detection segment 106 includes an opening 142 and the ground shield 220A on the outer surface of the OFIS device 100 and the ground shield 220B on the bottom surface of the OFIS device 100. The gas flow 156 passes through the filtering segment channel 230 between the top electrode 216A and the bottom electrode 216B. The gas flow 158 then passes through the detection segment channel 232 between the top detector electrode 204A and the bottom detector electrode 204B of the detection segment. In some embodiments, the ionization segment channel 228, filtering segment channel 230, and detection segment channel 232 are segments of a single, continuous channel.

In some embodiments, a height H1 of the ionization segment channel 228 and a height H3 of the detection segment channel 232 are greater than a height H2 of the filtering segment channel 230. In some embodiments, the height H1 of the ionization segment channel 228 is the same as or greater than the height H3 of the detection segment channel 232. In some embodiments, the height H1 of the ionization segment channel 228 is about 5X to about 7X the height H2 of the filtering segment channel 230. In some embodiments, the height H3 of the detection segment channel 232 is about 1X to about 5X the height H2 of the filtering segment. In some embodiments, the height H1 of the ionization segment channel 228 is about the same height H3 of the detection segment channel 232. In some embodiments, the widths of the ionization segment channel 228, filtering segment channel 230, and detection segment channel 232 are about the same. In some embodiments, the change in height of the detection segment channel 232 from the filtering segment channel 230 is a step up change, not a gradual change. The stepped channel geometry between the filtering and detection segments enables the detector electrodes 204A, 204B and ion guidance electrodes 265A, 265B to reside closer to the filter electrodes 216A, 216B reducing the loss of ions due to exposed dielectric surfaces as well as reducing the potential for voltage leakage. Thus, the stepped channel geometry provides higher ion transmission efficiency.

FIG. 2C is a schematic cross sectional view 260 of the integrated OFIS device 100 along line C-C of FIG. 2A passing through the filtering segment 104. FIG. 2C shows a cross-section 107 of the filtering segment 104 having an internal surface 105 surrounding the filtering segment channel 230. In some embodiments, a material of the body of the chamber 155 is one or more of but not limited to alumina, ceramic, LCP, PEEK, a low temperature co-fired ceramic (LTCC), or silicon or other semiconductor materials. As shown, the top and bottom filter electrodes 216A, 216B are arranged on opposing walls of the filtering segment channel 230. Surface heaters 225A, 225B are mounted over and are connected to the outer surface of the chamber 155. Power is supplied to the surface heaters 225A, 225B via the connection pads 172a, 172b on the outer surface of the body of the chamber 155 of the OFIS device 100. The surface heaters 225A and 225B are used for heating the ionization segment channel 228, the filtering segment channel 230, and the detection segment channel 232. In some embodiments, the temperature inside the chamber is set in a predetermined range between about the ambient temperature and about 200° C. As shown, a temperature sensor 222, such as a thermistor, is mounted on the OFIS device 100 and the sensor is connected to the control system 180 to measure the temperature of the OFIS device 100 via a control line 119. Based on the measured temperature, the control system 180 adjusts the temperature to be within the predetermined range by feedback control. In some embodiments, the thermistor 222 is connected to a connection pad 245. As shown, ground shields 220A, 220B extend parallel to a length of the detector electrodes 204A, 204B. In some embodiments, the surface heaters 225A, 225B do not overlap with the ground shields 220A, 220B but are located before and after the ground shields 220A, 220B and extend towards the opening 142. In some embodiments, the control system 180 also controls the ground shields 220A, 220B.

FIGS. 2D and 2E show a schematic top plan view of a two segment integrated OFIS device 103 and a cross sectional view along line D-D, respectively, according to an embodiment of the present disclosure. FIG. 2D shows a top plan view 201 of the integrated OFIS device or sensor 103 of FIG. 1B and shows the filtering segment 104, and the detection segment 106.

The carrier gas and material vapor flows from an ionization device 102 to the filtering segment 104 via an inlet 112. As discussed herein, the filtering segment 104 has two parallel filter electrodes 216A, 216B. FIG. 2D shows the top electrode 216A which is parallel to the bottom electrode 216B (shown in FIG. 2E) located below the top electrode 216A. The top and bottom electrodes 216A, 216B are connected through the connection lines 206a, 206b and connection pads 132a, 132b, 134a, and 134b on a body of the chamber 155 of the OFIS device 103 to the connection lines 197a, 197b, 207a, 207b that are connected to the voltage source 120 and the RF voltage source 130, respectively. The filtering segment 104 is connected through an interface 114 to the detection segment 106. The filtering segment 104 and the detection segment 106 have the same range of widths W2, W4 disclosed herein in reference to the three segment

OFIS device 100. In some embodiments the interface 114 has the same width as the width of the filtering segment 104. In some embodiments, there is a narrowing of a transition zone between the ionization device 102 and inlet 112, so that a gas flow entering the filtering segment 104 enters as a jet entry. In some embodiments, the pair of parallel filter electrodes 216A, 216B and the pair of parallel detector electrodes 204A, 204B are parallel to each other.

As discussed herein, the detection segment 106 has two parallel detector electrodes 204A, 204B. FIG. 2D shows the top detector electrode 204A which is parallel to the bottom detector electrode 204B (shown in FIG. 2E) located below the top detector electrode 204A. The top and bottom detector electrodes 204A, 204B are connected through the connection lines 212 and connection pads 144a, 144b on the body of the chamber 155 of the OFIS device 103 to the connection lines 184a, 184b that are connected to the detection system 140 that is connected to the voltage source 120 via the connection lines 192a, 192b. The detection segment 106 includes an opening 142 and the ground shields 220A, 220B on the outside surface of the OFIS device 103. The top ground shield 220A is parallel with a bottom ground shield 220B (shown in FIG. 2E). The top and bottom ground shields 220A, 220B are connected through the connection pads 240a, 240b on the body of the chamber 155 of the OFIS device 103 to the connection lines 121 that are connected to the voltage source 120. In some embodiments, the top and bottom ground shields 220A, 220B are connected to ground. In some embodiments, two ion guidance electrodes 265A, 265B are disposed parallel to each other on opposing sidewalls of the detection segment 106. The ion guidance electrodes 265A, 265B surround a periphery of the detector electrodes 204A, 204B. In some embodiments, the ion guidance electrodes 265A, 265B are connected to a DC voltage source 120 via two or more connection lines 188a, 188b. In some embodiments, the DC voltage source 120 includes a plurality of DC voltage sources (e.g.—a first DC voltage source, a second DC voltage source, a third DC voltage source, etc.) where each DC voltage source provides DC voltages to a different pair of opposing electrodes (e.g.—the filter electrodes 216A, 216B, the detector electrodes 204A, 204B, the ion guidance electrodes 265A, 265B, and the ground shields 220A, 220B). The ion guidance electrodes 265A, 265B increase the efficiency of the detection segment 106 by directing the material vapor ions to the detector electrodes 204A, 204B. The ion guidance electrodes 265A, 265B also prevent leakage current from the filtering segment 104 from impacting the detector electrodes 204A, 204B.

In some embodiments, the body of the chamber 155 of the OFIS device 103 has an indentation 202 defining an orientation of the OFIS device 103 when replacing the integrated OFIS device 103 in the OFIS system 113.

FIG. 2E is a schematic cross sectional view 251 along a length of the integrated OFIS device 103 of FIG. 2D along line D-D showing the filtering segment 104 and the detection segment 106. As shown in FIG. 2E, the filtering segment 104 has two parallel electrodes 216A and 216B that are respectively at the top and bottom of the filtering segment 104. The filtering segment 104 is connected through the interface 114 to the detection segment 106. The heights H2, H3 of filtering segment and detection segment are the same as the corresponding heights of the three segment integrated OFIS device 100 discussed herein.

The gas flow 156 passes through the filtering segment channel 230 between the top electrode 216A and the bottom electrode 216B. The gas flow 158 then passes through the detection segment channel 232 between the top detector electrode 204A and the top ion guidance electrode 265A and the bottom detector electrode 204B and the bottom ion guidance electrode 265B.

In some embodiments, the detection segment 106 has the same width as the filtering segment 104. In some embodiments, the width W2 of the filtering segment 104 and the width W4 of the detection segment 106 are half of the width W1 of the ionization segment 102. The stepped channel geometry between the filtering and detection segments enables the detector electrodes 204A, 204B and ion guidance electrodes 265A, 265B to reside closer to the filter electrodes 216A, 216B reducing the loss of ions due to exposed dielectric surfaces as well as reducing the potential for voltage leakage.

FIG. 2F shows a cross sectional view of the OFIS device illustrating movement of the ions, respectively, according to embodiments of the present disclosure. FIG. 2F is a schematic cross sectional view 290 along line B-B of the integrated OFIS devices 100 of FIG. 2A, or along line D-D of FIG. 2D for the two segment OFIS device 103. It is understood, the two segment OFIS device 103 does not include an integral ionization segment. In the case of the three segment OFIS device 100, the ionization segment 102 is part of the OFIS device 100. In the case of the two segment OFIS device 103, the ionization segment 102 is a separate component of the OFIS system 113. The carrier gas flow 152 and the material vapor flow 154 are mixed in the ionization segment 102 and pass through the ionizing tool 125. The ionizing tool 125 generates positive ions 218 and negative ions 217 and produces the gas flow 156 that passes through the filtering segment channel 230. Thus, the gas flow 156 includes the positive ions 218, negative ions 217, and neutral atoms/molecules.

During operation, DC voltages are applied to the ionization region electrodes 255A, 255B in the ionization region. A negative DC voltage −VDC1a is applied to the top electrode 255A and a positive DC voltage +VDC1b is applied to the bottom electrode 255B by the voltage source 120 in some embodiments. In other embodiments, the positive voltage is applied to the top electrode 255A and the negative voltage is applied to the bottom electrode 255B. In some embodiments, the applied voltages +VDC1a and −VDC1b range from about −20 V to about +20 V, while in other embodiments the applied voltages range from about −10 V to about 10 V. FIG. 2F shows the jet entry embodiment, as illustrated by the narrowed opening at the interface 112 between the ionization segment 102 and the filtering segment 104.

During operation, DC voltages are applied to the parallel filter electrodes 216A, 216B in the filtering segment. A negative DC voltage −VDC2a is applied to the top electrode 216A and a positive DC voltage +VDC2b is applied to the bottom electrode 216B by the voltage source 120 in some embodiments. In other embodiments the positive voltage is applied to the top electrode 216A and the negative voltage is applied to the bottom electrode 216B. In addition, an RF voltage VRF as described with reference to FIG. 1C is applied between the top electrode 216A and the bottom electrode 216B. As shown in FIG. 2F, the combination of the DC and the RF voltages causes some of the ions to get discharged by contacting the electrodes 216A, 216B in the filtering zone 104 and some negative ions and positive ions exit the filtering segment 104 and enter the detection segment 106. Although, one ion is shown contacting each of the detector electrodes 204A, 204B, a plurality of ions contact the detector electrodes 204A, 204B in some embodiments. In some embodiments, the applied voltages +VDC2a and −VDC2b range from about −45 V to about +20 V, while in other embodiments the applied voltages range from about −40 V to about +15 V.

During operation, a negative DC voltage −VDC3a is applied to the top detector electrode 204A and a positive DC voltage +VDC3b is applied to the bottom detector electrode 204B by the voltage source 120 in some embodiments. In other embodiments, the positive voltage is applied to the top electrode 204A and the negative voltage is applied to the bottom electrode 204B. The application of the voltages −VDC3a and +VDC3b cause the positive and negative ions to be discharged, e.g., detected, by the respective top detector electrode 204A and the bottom detector electrode 204B. As shown, the discharged ions leave the detection segment as part of the exhaust gas flow 160 through the opening 142. In some embodiments, the voltages applied to the detector electrodes 204A, 204B ranges from about −20 volts to about +20 volts with the detector electrodes 204A and 204B having opposite polarities, while in other embodiments, the voltages −VDC3a and +VDC3b range from about −10 V to about +10 V. During operation, DC voltages are applied to the ion guidance electrodes 265A, 265B during operation to guide the ions to the detector electrodes 204A, 204B. A negative DC voltage −VDC4a is applied to the top ion guidance electrode 265A and a positive DC voltage +VDC4b is applied to the bottom ion guidance electrode 265B by the voltage source 120 in some embodiments. In other embodiments, the positive voltage is applied to the top electrode 265A and the negative voltage is applied to the bottom electrode 265B. In some embodiments, the applied voltages +VDC4a and −VDC4b range from about −20 V to about +20 V, while in other embodiments the applied voltages range from about −10 V to about 10 V. In some embodiments, the voltage applied to the top ion guidance electrode 265A and the bottom ion guidance electrode 265B are about the same as the corresponding top and bottom detector electrodes 204A, 204B.

In some embodiments, −VDC2a or −VDC3a ranges between about −3 volts to about −15 volts and +VDC2b or +VDC3b ranges from about 3 volts to about 15 volts. In other embodiments −VDC2a or −VDC3a ranges from about −4.7 to about −12.5 volts and +VDC2a or +VDC3a ranges from about 4.7 volts to about 12.5 volts. In some embodiments, −VDC2a is applied to the top electrode 216A and +VDC2b is applied to the bottom electrode 216B, while +VDC3a is applied to the top detector electrode 204A and −VDC3a is applied to the bottom detector electrode 204B. In some embodiments, +VDC2b is applied to the top electrode 216A and −VDC2a is applied to the bottom electrode 216B, while +VDC3b is applied to the top detector electrode 204A and −VDC3a is applied to the bottom detector electrode 204B. In some embodiments, 0 V is applied to top electrode 216A or the bottom electrode 216B and a positive or negative voltage is applied to the other electrode.

In some embodiments, the flow of the ions depends on the charge of the ions and the mobility of the ions, and the voltages applied to the top electrode 216A and the bottom electrode 216B. In some embodiments, the ion flow is programmed and controlled by the control system 180. Higher flow may provide higher sensitivity in some embodiments, and higher DC voltage applied to the filter electrodes 216A, 216B may provide improved ion filtering.

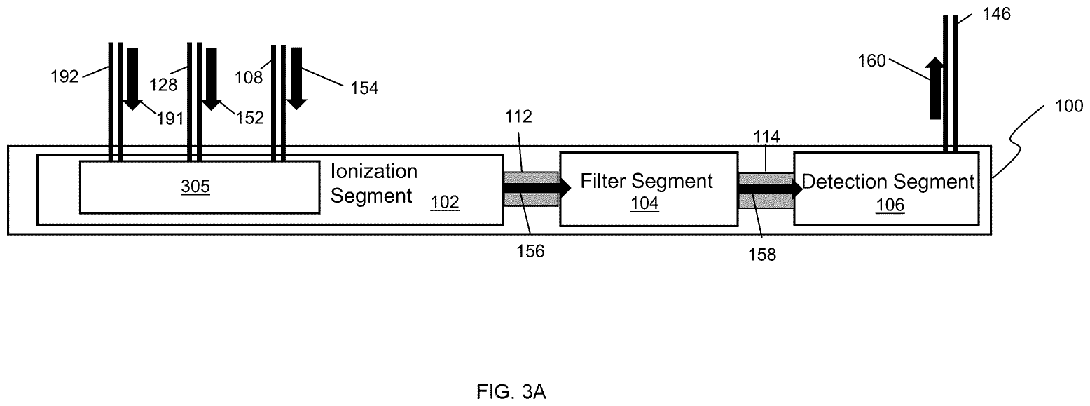

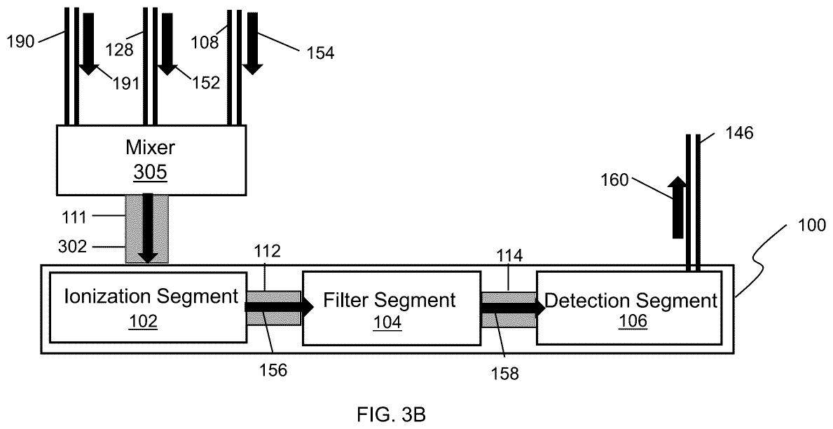

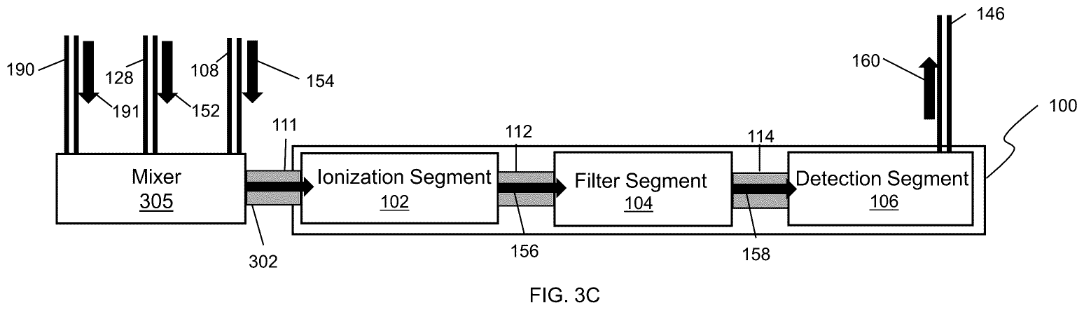

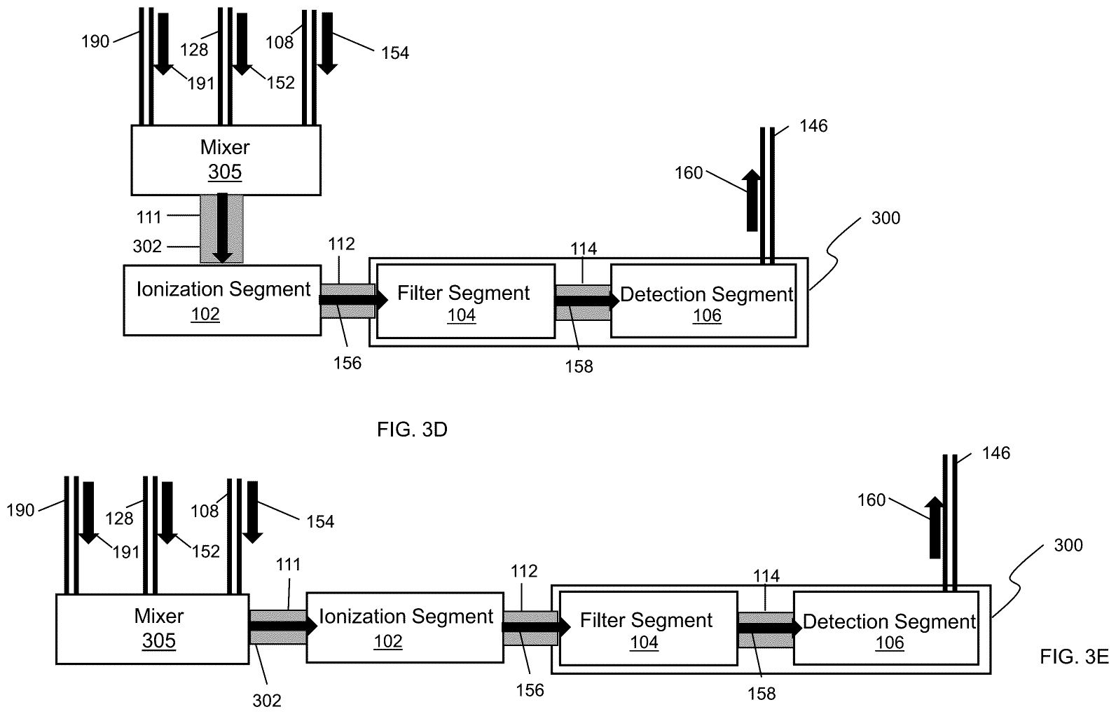

FIGS. 3A, 3B, 3C, 3D, and 3E show embodiments of integrated OFIS devices according to the present disclosure. FIG. 3A shows the three segment integrated OFIS device 100. A body of the integrated OFIS device 100 of FIG. 3A is consistent with the chamber 155 of FIG. 1A and includes the ionization segment 102, the filtering segment 104 connected to the ionization segment 102 through the interface 112, and the detection segment 106 connected to the filtering segment 104 through the interface 114. The difference is that FIG. 3A includes a mixer 305 in the ionization segment 102 such that the carrier gas flow 152, the material vapor flow 154, and the modifier gas 190 are mixed in the mixer 305 and then the mixture is ionized. As shown in FIGS. 3B and 3C, the mixer 305 is outside the integrated OFIS device 100 in some embodiments and the mixture is transferred via an interface 302 and by a flow 111 to the ionization segment 102. In some embodiments, the flow 111 is a sum of the carrier gas flow 152, material vapor flow 154, and the modifier gas 191. FIG. 3B is consistent with FIG. 3A with a difference that the mixer 305 and interface 302 are outside the ionization segment 102 and are not in the same line with the ionization segment 102, filter segment 104, and detection segment 106. FIG. 3C is consistent with FIG. 3B with the difference that the mixer 305 is in the same line with the ionization segment 102, filter segment 104, and detection segment 106.

FIG. 3D is consistent with FIG. 3B with a difference that the ionization segment 102 is located outside a two segment integrated OFIS device 103 and similar to FIG. 3B, the mixer 305 and interface 302 are not in the same line as the ionization segment 102, filter segment 104, and detection segment 106. FIG. 3E is consistent with FIG. 3C with a difference that the ionization segment 102 is located outside the two segment integrated OFIS device 103 and the interface 302 is in a straight line arrangement with the ionization segment 102, the filter segment 104, and the detection segment 106.

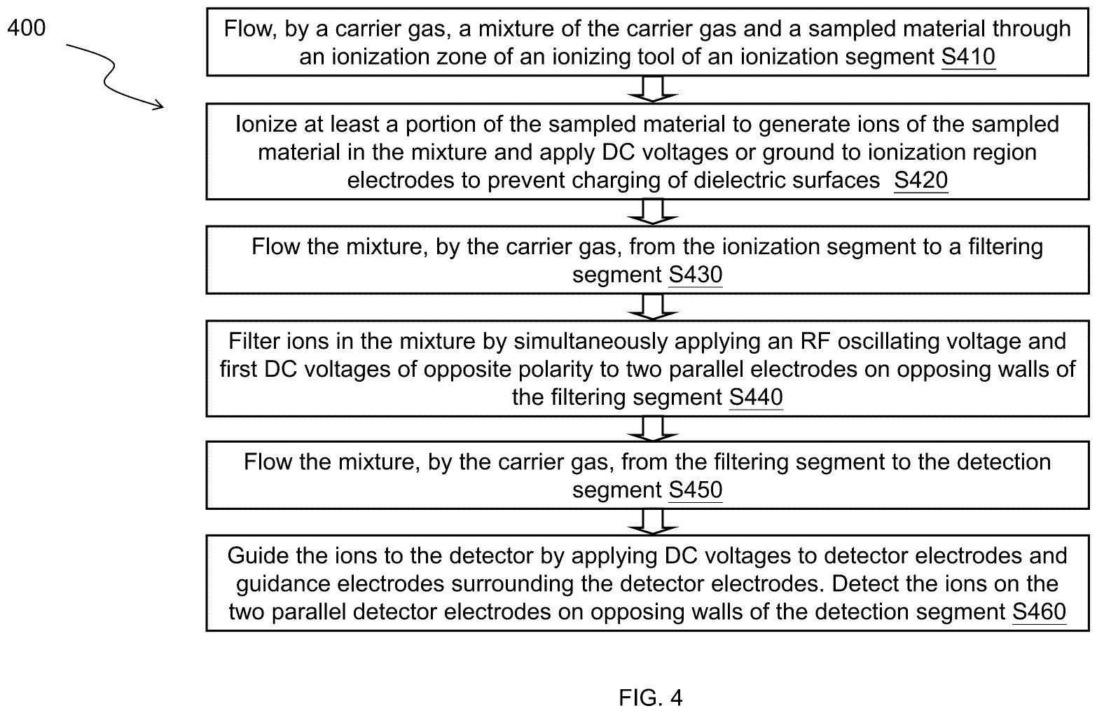

FIG. 4 shows a flow diagram of a process 400 for operating an OFIS device in accordance with some embodiments of the present disclosure. In some embodiments, as shown in FIGS. 1A and 1B, in operation S410, a mixture of the carrier gas and a material vapor flow, by the carrier gas, through an ionization zone 210 of the ionizing tool 125 of an ionization segment 102. In operation S420, at least a portion of the material vapor is ionized to generate ions of the material vapor in the mixture. DC voltages or ground is applied to the ionization region electrodes 255A, 255B to prevent charging of dielectric surfaces in the ionization segment 102. The mixture flows, by the carrier gas, from the ionization segment 102 to a filtering segment 104 in operation S430. In operation S440, ions in the mixture are filtered by simultaneously applying an RF oscillating voltage VRF and DC voltages of opposite polarity +VDC1/−VDC1 to two parallel filter electrodes 216A, 216B on opposing walls of the filtering segment 104. In operation S450, the mixture flows, by the carrier gas, from the filtering segment 104 to the detection segment 106. In operation S460, the ions are guided by applying DC voltages to ion guidance electrodes 265A, 265B surrounding the detector electrodes. The guided ions are detected by applying DC voltages to two parallel detector electrodes 204A, 204B on opposing walls of the detection segment.

In some embodiments, in operation S410, the material vapor is a vapor of a predefined material. In some embodiments, the material vapor intermittently flows through the OFIS device. In some embodiments, the material vapor is introduced by human breath.

FIGS. 5A, 5B, and 5C show an ionization segment of integrated OFIS devices according to embodiments of the disclosure. FIGS. 5A, 5B, and 5C show the ionization segment 102 and the ionization zone 210 inside the ionization segment 102. In FIG. 5A, the carrier gas flow 152, material vapor flow 154, and the modifier gas flow 191 enter the ionization segment 102 and get mixed and then the mixture is ionized in the ionization zone 210. Thus, the carrier gas flow, the material vapor, and the modifier gas may be ionized together. In FIG. 5B, the carrier gas flow 152 and the modifier gas flow 191 enter the ionization segment 102 and get mixed and then the mixture is ionized in the ionization zone 210. Then further along, the material vapor flow 154 enters the ionization segment 102 and gets ionized by the ionized carrier gas and/or modifier gas. FIG. 5C is similar to FIG. 5B except that modifier gas flow 191 enters before the carrier gas flow 152, while in FIG. 5C, the material vapor flow 154 enters the ionization segment 102 further along and gets ionized by the ionized carrier gas.

In some embodiments, a three segment OFIS device 100 contains one or more inlet ports 124, 126, 182, an ionization segment 102, a filter segment 104, a detector segment 106, and an exhaust port 142, all of which are connected by a single channel. All the components are contained within a single device with shielding, ground shields 220A, 220B, heaters 225A, 225B, temperature sensors 222, and electrical connection pads 122a, 122b, 132a, 132b, 134a, 134b, 144a, 144b, 145a, 145b, 172a, 172b, 219a, 219b, 240a, 240b, 245, on the outer surfaces. Ionization region electrodes 255A, 255B, filter electrodes 216A, 216B, detector electrodes 204A, 204B, ion guidance electrodes 265A, 265B within the single inline channel apply shielding, RF voltage, DC voltages, and ion count measurement in different segments.

In some embodiments of the three segment OFIS device 100, mixing occurs within the device or external to the device. The ionization segment may include a single inlet or multiple inlets, wherein the inlets may include a material vapor inlet 126, a carrier gas inlet 124, and a modifier inlet 182 in various orders of introduction, and the inlets may be inline or angled relative to the channel. The ionization segment 102 may include parallel ionization region electrodes 255A, 255B attached to a DC voltage source 120 or ground, an ionization viewing window 213, electrical connections to the outer surface of the device, and an ionization tool 125.

The ionization tool 125 may be integrated between the inlet ports 124, 126, 182 or after the inlet ports 124, 126, 182. In some embodiments, non-radioactive ionization is used. The non-radioactive ionization includes, but is not limited to capacitive discharge ionization (plasma), UV ionization, electrospray ionization. In other embodiments, radioactive ionization is used. In some embodiments, a single ionization source 125 is used. In other embodiments, multiple, different ionization sources may be used.

In some embodiments of the three segment OFIS device 100, there is a channel restriction in the transition zone 211 between the ionization segment 102 and the filtering segment 104 to funnel the ions into the filtering segment 102, thereby providing a jet effect increasing the ion flowrate. In some embodiments, the channel dimensions of the filtering segment 104 are different from the ionization segment 102. The filtering segment 104 further includes a pair of filter electrodes 216A, 216B on opposing surfaces of the channel 230. In some embodiments, in the application of RF and DC voltages, opposite polarities are split between the electrodes and are summed to the total voltage (e.g. all the voltage may be applied to one electrode with 0V applied to the other electrode.)In some embodiments, the DC voltages are applied singularly, in discreet steps, in a full range scan, a partial range scan, or multiple partial range scans. The filtering segment 104 includes electrical connections to the outer surface of the device.

In some embodiments of the three segment OFIS device 100, the detection segment 106 includes a pair of detector electrodes 204A, 204B on opposing surfaces of the channel 232 and a pair of ion guidance electrodes 265A, 265B surrounding the detector electrodes 204A, 204B. The polarities of the shield and offset voltages may match or oppose the filter electrodes for each side. The shield and offset voltages may be fixed voltage or varying voltage. The detection segment 106 may include an inline exhaust port outlet 142 or an angled exhaust port outlet relative to the channel 232. The detection segment 106 may further include electrical connection pads on the outer surface of the device. In some embodiments, the channel 232 dimensions of the detection segment 106 are different from the channel 230 dimensions of the filtering segment 104.

In some embodiments, a two segment OFIS device 103 contains one or more inlet ports 112, a filter segment 104, a detector segment 106, and an exhaust port 142, all of which are connected by a single channel 230, 232. All the components are contained within a single device with shield grounds 220A, 220B, heaters 225A, 225B, temperature sensor 222, and electrical connection pads 132a, 132b, 134a, 134b, 144a, 144b, 145a, 145b, 172a, 172b, 240a, 240b, 245 on the outer surfaces. Parallel filter electrodes 216A, 216B, detector electrodes 204A, 204B, and ion guidance electrodes 265A, 265B within the single inline channel apply shielding, RF voltage, DC voltages, and ion count measurement in different segments. In some embodiments, the two segment OFIS device 103 is paired with an external mixing/ionization device 305/102 in operation.

In some embodiments of the two segment OFIS device 103, a channel restriction is in the transition zone between the external ionization device 102 and the filtering segment 104 to funnel the ions into the filtering segment 104, thereby providing a jet effect. In some embodiments, the filtering segment 104 includes a single inlet port 112 from the ionization device 102. In some embodiments, in the application of RF and DC voltages, opposite polarities are split between the filter electrodes 216A, 216B and are summed to the total voltage (e.g. all the voltage may be applied to one electrode with 0V applied to the other electrode.) In some embodiments, the DC voltages are applied singularly, in discreet steps, in a full range scan, a partial range scan, or multiple partial range scans. The filtering segment 104 includes electrical connection to the outer surface of the device.

In some embodiments of the two segment OFIS device 103, the polarities of the shield and offset voltages may match or oppose the filter electrodes 216A, 216B for each side. The shield and offset voltages may be fixed voltage or varying voltage. The detection segment 106 may include an inline exhaust port outlet 142 or an angled exhaust port outlet relative to the channel. The detection segment 106 further includes electrical connections to the outer surface of the device. In some embodiments, the channel dimensions of the detection segment are different from the filtering segment.

In some embodiments, the two segment OFIS device 103 or the three segment OFIS device 100 is a replaceable, disposable components of an OFIS system 110, 113. When the sensitivity of the OFIS device 100, 103 falls below a threshold value, the OFIS device 100, 103 can be easily removed from the OFIS system 110, 113 and replaced with a replacement OFIS device 100, 103. Alternatively, the ionization device 102 used with the two segmented OFIS device 103 is a replaceable component in some embodiments.

In the embodiments described above, because the ionization occurs inside the integrated OFIS devices and may be performed by a non-radioactive method of generating a plasma region, the integrated OFIS devices are safe and not subjected to radioactive source regulations and inspections. In some embodiments, the non-radioactive source may include redundancy for wear elements to extend usable service life. In addition, when the OFIS device fails, e.g., fails calibration, the integrated OFIS device is easily and quickly replaced and no alignment is required.

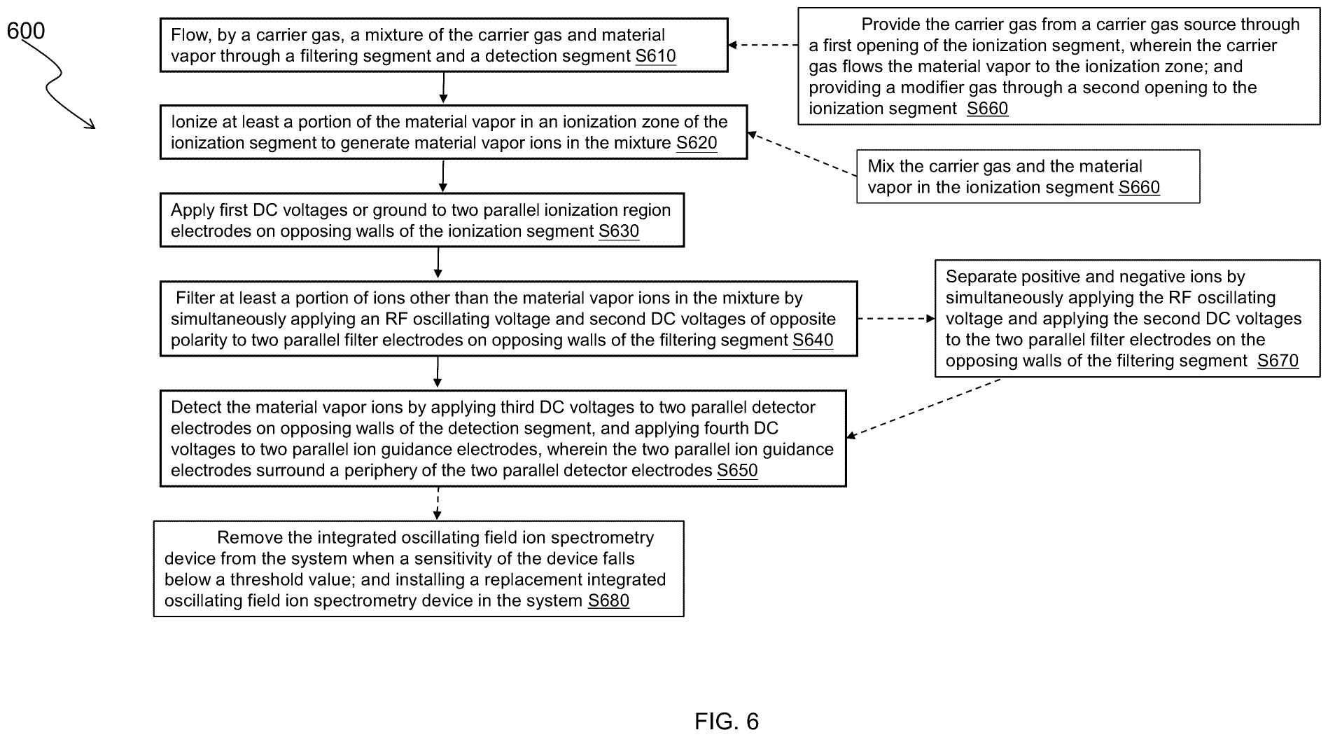

A flow diagram of a method for operating an OFIS system in accordance with some embodiments of the present disclosure is shown in FIG. 6. In operation S610, a carrier gas, a mixture of the carrier gas and material vapor is flowed through a filtering segment 104 and a detection segment 106. At least a portion of the material vapor is ionized in an ionization zone of the ionization segment 102 to generate material vapor ions in the mixture in operation S620. Then, first DC voltages or ground is applied, in operation S630, to two parallel ionization region electrodes 255A, 255B on opposing walls of the ionization segment. In operation S640, at least a portion of ions other than the material vapor ions in the mixture are filtered by simultaneously applying an RF oscillating voltage and second DC voltages of opposite polarity to two parallel filter electrodes 216A, 216B on opposing walls of the filtering segment 104. The material vapor ions are subsequently detected by applying third DC voltages to two parallel detector electrodes 204A, 204B on opposing walls of the detection segment 106, and applying fourth DC voltages to two parallel ion guidance electrodes 265A, 265B, wherein the two parallel ion guidance electrodes 265A, 265B surround a periphery of the two parallel detector electrodes 204A, 204B in operation S650. In some embodiments, the carrier gas is provided from a carrier gas source 116 through a first opening 124 of the ionization segment 102, wherein the carrier gas flows the material vapor to the ionization zone; and a modifier gas is provided through a second opening 182 to the ionization segment 102 in operation S660. In some embodiments, in operation S670, the carrier gas and the material vapor are mixed in the ionization segment 102. The positive and negative ions are separated in some embodiments by simultaneously applying the RF oscillating voltage and applying the second DC voltages to the two parallel filter electrodes 216A, 216B on the opposing walls of the filtering segment 104, in operation S670. In some embodiments, in operation S680 the integrated oscillating field ion spectrometry device is removed from the system when a sensitivity of the device falls below a threshold value; and a replacement integrated oscillating field ion spectrometry device is installed in the system.

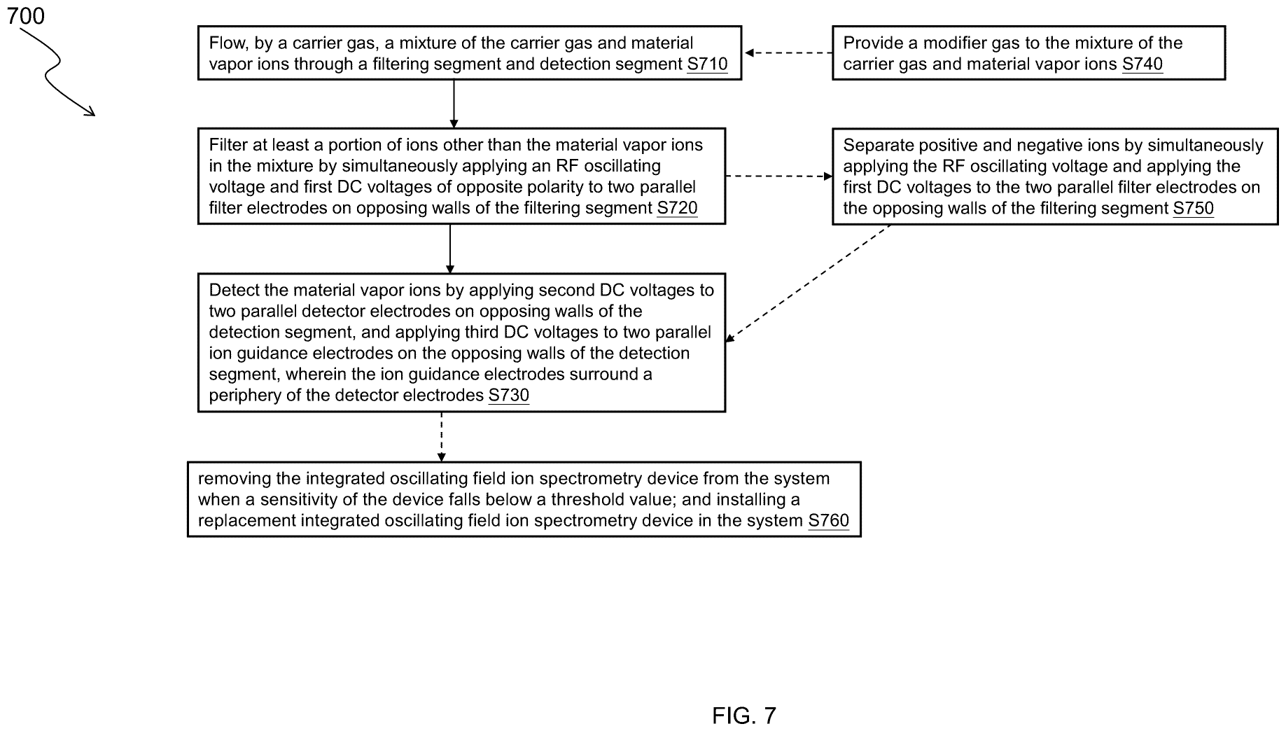

A flow diagram of a method for operating an OFIS system in accordance with some embodiments of the present disclosure is shown in FIG. 7. In operation S710, a mixture of a carrier gas and material vapor ions are flowed by the carrier gas through a filtering segment 104 and a detection segment. At least a portion of ions other than the material vapor ions in the mixture are filtered in operation S720 by simultaneously applying an RF oscillating voltage and first DC voltages of opposite polarity to two parallel filter electrodes 216A, 216B on opposing walls of the filtering segment 104. Then, in operation S730, the material vapor ions are detected by applying second DC voltages to two parallel detector electrodes 204A, 204B on opposing walls of the detection segment 106, and applying third DC voltages to two parallel ion guidance electrodes 265A, 265B on the opposing walls of the detection segment 106, wherein the ion guidance electrodes 265A, 265B surround a periphery of the detector electrodes 204A, 204B. In some embodiments, in operation S740, a modifier gas is provided to the mixture of the carrier gas and material vapor ions. In some embodiments, the positive and negative ions are separated by simultaneously applying the RF oscillating voltage and applying the first DC voltages to the two parallel filter electrodes 216A, 216B on the opposing walls of the filtering segment 104 in operation S740. In some embodiments, in operation S750, the integrated oscillating field ion spectrometry device 103 is removed from the system when a sensitivity of the device falls below a threshold value; and a replacement integrated oscillating field ion spectrometry device is installed in the system.

A method of calibrating an integrated oscillating field ion spectrometry device having a single channel chamber divided into three segments including an ionization segment 102, a filtering segment 104, and a detection segment 106 arranged in order is included in some embodiments of the disclosure. The filtering segment 104 is located downstream from the ionization segment 102 in a direction of flow of a carrier gas. The detection segment 106 is located downstream from the filtering segment 104 in the direction of flow of the carrier gas. The method includes flowing, by the carrier gas, a mixture of the carrier gas and a predetermined amount of a calibrating material through an ionization zone of an ionizing tool 125 of the ionization segment 102 and ionizing the calibrating material to generate calibrating material ions in the mixture. The mixture is flowed by the carrier gas from the ionization segment to the filtering segment 104 and at least a portion of ions other than the calibrating material ions in the mixture are filtered by simultaneously applying an RF oscillating voltage and first DC voltages of opposite polarity to two parallel electrodes 216A, 216B on opposing walls of the filtering segment 104. The mixture is flowed by the carrier gas, from the filtering segment 104 to the detection segment 106 and the ions of the calibrating material are detected by applying second DC voltages to two parallel electrodes 204A, 204B on opposing walls of the detection segment 106 to discharge the ions of the calibrating material. An amount of the discharged calibrating material is determined and when the amount of the discharged calibrating material is above a threshold amount of the predetermined amount of the calibrating material, the calibration is successful. In some embodiments, the OFIS device is calibrated with a material that is chemically similar or is the same as the material vapors to be subsequently detected. In some embodiments, the calibration occurs as a separate cycle without material vapor. In some embodiments, the calibration occurs as part of an analysis cycle with material vapor.

In some embodiments, the RF oscillating voltage and the first DC voltages are applied to the two parallel electrodes 216A, 216B on the opposing walls of the filtering segment 104 and the second DC voltages are applied to two parallel detector electrodes 204A, 204B on the opposing walls of the detection segment 106. In some embodiments, the threshold amount is about 90% or more of the predetermined amount of the calibrating material. If adjusting the parameters does not result in a successful calibration, a signal is generated by a control system 180 of OFIS system 110 that the integrated OFIS device 100 needs replacement in some embodiments. In some embodiments, the three segment OFIS device 100 is disposable. The three segment OFIS device 100 can be removed from the OFIS system and replaced by a replacement three segment OFIS device.

In some embodiments, the result from the calibrating material is registered and the detection algorithm may dynamically alter the measured values of the material vapor. For example (using arbitrary numbers for illustration) if the calibrating material normally measures 100 in a properly functioning system and the material vapor would normally measure 50 in that properly functioning system, and the calibrating only measures 90 indicating that system sensitivity has degraded, the material vapor would also show a decreased value. In this case, the algorithm may boost the measured value accordingly based upon the calibrating material's decrease measurement, so the system may continue functioning with a uniform consistency of sensitivity. There also would be a threshold for the calibrating material measurement, for example 70, which would indicate the system sensitivity is too low to be acceptable. In this case the system would notify the operator to replace the OFIS device or seek service.

The two segment OFIS device 103 disclosed herein may be calibrated in a similar manner as the three segment OFIS device 100. Similarly, the two segment OFIS device 103 is disposable, and can be removed and replaced by a replacement two segment OFIS device. The ionization segment 102 remains a part of the OFIS system 113 when the disposable two segment OFIS device 103 is removed and replaced.

It will be understood that not all advantages have been necessarily discussed herein, no particular advantage is required for all embodiments or examples, and other embodiments or examples may offer different advantages.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated oscillating field ion spectrometry device, comprising:
a chamber divided into at least three connected segments that comprises an ionization segment, a filtering segment, and a detection segment arranged in order, wherein the filtering segment is located downstream from the ionization segment in a direction of flow of a carrier gas, and the detection segment is located downstream from the filtering segment in the direction of flow of the carrier gas, wherein:
the ionization segment comprises:
a first opening and a second opening, wherein the carrier gas flows through the first opening into a first channel region in the ionization segment, and a material vapor flows through the second opening into the first channel region of the ionization segment;
an ionizing tool mounted in the first channel region configured to ionize the material vapor; and
two parallel ionization region electrodes on opposing walls of the first channel region, wherein the two parallel ionization region electrodes are connected to a first DC voltage source or to ground, and the two parallel ionization region electrodes are configured to prevent charging of dielectric surfaces in the ionization segment;
the filtering segment comprises:
two parallel filter electrodes on opposing walls of a second channel region of the filtering segment that are parallel to the direction of flow of the carrier gas, wherein the two parallel filter electrodes are connected to a second DC voltage source to receive second DC voltages of opposite polarity, the two parallel filter electrodes are connected to a radio frequency (RF) voltage source to receive an RF oscillating voltage in addition to the second DC voltages, wherein the two parallel filter electrodes are configured to generate electric fields by the second DC voltages and the RF oscillating voltage to filter ions passed from the ionization segment;
and the detection segment comprises:
two parallel detector electrodes on opposing walls of a third channel region of the detection segment that are parallel to the direction of flow of the carrier gas, wherein the two parallel detector electrodes are connected to a third DC voltage source to receive third DC voltages and are connected to a detection system, wherein the two parallel detector electrodes are configured to generate an electric field by the third DC voltages to attract filtered material vapor ions; and
two parallel ion guidance electrodes on opposing walls of the third channel region, wherein the ion guidance electrodes surround a periphery of the detector electrodes, the two parallel ion guidance electrodes are connected to a fourth DC voltage source to receive fourth DC voltages, and the two parallel ion guidance electrodes are configured to generate an electric field to guide ions to the two parallel detector electrodes,
wherein the detection segment is configured to count a number of positive and negative ions of the material vapor, and
wherein the first channel region, the second channel region, and the third channel region are arranged along a line and form a single channel.

2. The integrated oscillating field ion spectrometry device of claim 1, further comprising:
a first interface between the ionization segment and the filtering segment,
wherein the ionization segment has a transition region next to the first interface, and a width of the transition region is tapered from a first width to a second width, wherein the second width is a width of the first interface, and the second width is between 2 to 5 times smaller than the first width.

3. The integrated oscillating field ion spectrometry device of claim 1, further comprising one or more ground shields on an outer surface of the detection segment.

4. The integrated oscillating field ion spectrometry device of claim 1, wherein the ionization segment further comprises a viewing window, and wherein an ionization zone is viewable from the viewing window.

5. The integrated oscillating field ion spectrometry device of claim 1, wherein the ionizing tool comprises a plasma source.

6. The integrated oscillating field ion spectrometry device of claim 1, wherein an electric field generated by the second DC voltages of opposite polarity in the second channel region has a direction that is opposite to the electric field generated by the third DC voltages in the third channel region.

7. The integrated oscillating field ion spectrometry device of claim 1, wherein outside walls of the chamber comprise a plurality of connection pads electrically connected to each one of the two parallel ionization region electrodes, the two parallel filter electrodes, the two parallel detector electrodes, the two parallel ion guidance electrodes, and the ionizing tool.

8. The integrated oscillating field ion spectrometry device of claim 1, further comprising:
a control system that is coupled to the first, second, third, and fourth DC voltage sources, the RF voltage source, and the detection segment, wherein, the control system is configured to control the second DC voltage source to adjust the second DC voltages and to adjust an amplitude or a frequency of the RF oscillating voltage of the RF voltage source, and configured to control the first DC voltages, the third DC voltages, and the fourth DC voltages.

9. The integrated oscillating field ion spectrometry device of claim 8, wherein an electric field generated by the second DC voltages of opposite polarity in the second channel region has a direction that is a same direction as the electric field generated by the third DC voltages in the third channel region.

10. The integrated oscillating field ion spectrometry device of claim 8, wherein:
the ionization segment further comprises a first opening and a second opening, wherein the carrier gas flows through the first opening into the ionization segment, and the material vapor flows through the second opening into the ionization segment.

11. An oscillating field ion spectrometry system, comprising:
an integrated oscillating field ion spectrometry device; and
an ionization device coupled along a gas flow to the integrated oscillating field ion spectrometry device,
wherein the ionization device includes an ionizing tool mounted in the ionization device, wherein the ionizing tool is configured to ionize a material vapor; and
two parallel ionization region electrodes on opposing walls of the ionization device, wherein the two parallel ionization region electrodes are connected to a first DC voltage source or to ground, and the two parallel ionization region electrodes are configured to prevent charging of dielectric surfaces in the ionization device;
wherein the integrated oscillating field ion spectrometry device comprises:
a chamber divided into at least two connected segments comprising a filtering segment and a detection segment arranged in order, wherein the detection segment is located after the filtering segment in a direction of flow of a carrier gas, and the filtering segment is located downstream from the ionization device;
wherein the filtering segment comprises:
two parallel filter electrodes on opposing walls of a first channel region of the filtering segment that are parallel to the direction of flow of the carrier gas, wherein the two parallel filter electrodes are connected to a second DC voltage source to receive second DC voltages of opposite polarity, the two parallel filter electrodes are connected to a radio frequency (RF) voltage source to receive an RF oscillating voltage in addition to the second DC voltages, wherein the two parallel filter electrodes are configured to generate electric fields by the second DC voltages and the RF oscillating voltage to filter ions passed from the ionization device; and
the detection segment comprises:
two parallel detector electrodes on opposing walls of a second channel region of the detection segment that are parallel to the direction of flow of the carrier gas, wherein the two parallel detector electrodes are connected to a third DC voltage source to receive third DC voltages and are connected to a detection system, wherein the two detector parallel electrodes are configured to generate an electric field by the third DC voltages to attract material vapor ions or other modified ions of interest, wherein the detection system is configured to determine a number of positive and negative ions of the material vapor; and
two parallel ion guidance electrodes on opposing walls of the second channel region, wherein the ion guidance electrodes surround a periphery of the detector electrodes, the two parallel ion guidance electrodes are connected to a fourth DC voltage source to receive fourth DC voltages, and the two parallel ion guidance electrodes are configured to generate an electric field to guide ions to the two parallel detector electrodes.

12. The oscillating field ion spectrometry system of claim 11, wherein the first channel region and the second channel region are arranged along a line and form a single channel.

13. The oscillating field ion spectrometry system of claim 11, wherein an electric field generated by the second DC voltages of opposite polarity in the first channel region has a direction that is opposite to the electric field generated by the third DC voltages in the second channel region.

14. The oscillating field ion spectrometry system of claim 11, wherein outside walls of the chamber comprise a plurality of connection pads electrically connected to each one of the two parallel filter electrodes, the two parallel detector electrodes, and the two parallel ion guidance electrodes.

15. The oscillating field ion spectrometry system of claim 11, wherein the integrated oscillating field ion spectrometry device is a replaceable component of the oscillating field ion spectrometry system.

16. The oscillating field ion spectrometry system of claim 11, further comprising one or more shield grounds located on an outer surface of the detection segment.

17. The oscillating field ion spectrometry system of claim 11, further comprising:
a control system that is coupled to the second, third, and fourth DC voltage sources, the RF voltage source, and the detection segment, wherein, the control system is configured to control the second voltage source to adjust the second DC voltages and to adjust an amplitude or a frequency of the RF oscillating voltage of the RF voltage source, and configured to control the second DC voltages, the third DC voltages, and the fourth DC voltages.

18. An integrated oscillating field ion spectrometry device, comprising:
a chamber divided into at least two connected segments comprising a filtering segment and a detection segment, wherein the detection segment is located downstream from the filtering segment in a direction of flow of a carrier gas,
wherein the filtering segment comprises:
two parallel filter electrodes on opposing walls of a filtering segment channel region that are parallel to a direction of flow of the carrier gas, wherein the two parallel filter electrodes are connected to a first DC voltage source to receive first DC voltages of opposite polarity, and are connected to a RF voltage source to receive an RF oscillating voltage; and
wherein the detection segment comprises:
two parallel detector electrodes on opposing walls of a detection segment channel region that are parallel to the direction of flow of the carrier gas, wherein the two parallel detector electrodes are connected to a second DC voltage source to receive second DC voltages, wherein the detection segment is configured to determine a number of positive and negative ions of a material vapor; and two parallel ion guidance electrodes on opposing walls of the detection segment channel region, wherein the ion guidance electrodes surround a periphery of the detector electrodes, the two parallel ion guidance electrodes are connected to a third DC voltage source to receive third DC voltages, and the two parallel ion guidance electrodes are configured to generate an electric field to guide ions to the two parallel detector electrodes.

19. The integrated oscillating field ion spectrometry device of claim 18, further comprising an ionization segment upstream from the filtering segment along the direction of flow of the carrier gas,
wherein the ionization segment comprises:
one or more inlets;
an ionization segment channel region;
an ionization source in the ionization segment channel region selected from the group consisting of a cross-wire capacitive discharge ionizer, an ultraviolet ionizer, an electrospray ionizer, a radioactive ionizer, and combinations thereof, wherein the ionization source is configured to ionize a material vapor; and
two parallel ionization region electrodes on opposing walls of the ionization segment channel region, wherein the two parallel ionization region electrodes are connected to a fourth DC voltage source or to ground, and the two parallel ionization region electrodes are configured to prevent charging of dielectric surfaces in the ionization segment.

20. The integrated oscillating field ion spectrometry device of claim 19, wherein a height of the filtering segment channel region is less than a height of the ionization segment channel region, and a height of the detection segment channel region is greater than a height of the filtering segment channel region.

21. A method of operating an integrated oscillating field ion spectrometry system, including an integrated oscillating field ion spectrometry device, wherein the integrated oscillating field ion spectrometry device comprises a chamber divided into at least three segments comprising: an ionization segment, a filtering segment, and a detection segment arranged in order in a direction of flow of a carrier gas, comprising:
flowing, by the carrier gas, a mixture of the carrier gas and material vapor through the filtering segment and the detection segment;
ionizing at least a portion of the material vapor in an ionization zone of the ionization segment to generate material vapor ions in the mixture;
applying first DC voltages or ground to two parallel ionization region electrodes on opposing walls of the ionization segment;
filtering at least a portion of ions other than the material vapor ions in the mixture by simultaneously applying an RF oscillating voltage and second DC voltages of opposite polarity to two parallel filter electrodes on opposing walls of the filtering segment; and
detecting the material vapor ions by applying third DC voltages to two parallel detector electrodes on opposing walls of the detection segment, and applying fourth DC voltages to two parallel ion guidance electrodes, wherein the two parallel ion guidance electrodes surround a periphery of the two parallel detector electrodes.

22. The method of claim 21, further comprising:
providing the carrier gas from a carrier gas source through a first opening of the ionization segment, wherein the carrier gas flows the material vapor to the ionization zone; and
providing a modifier gas through a second opening to the ionization segment.

23. The method of claim 21, further comprising:
mixing the carrier gas and the material vapor in the ionization segment.

24. The method of claim 21, wherein the filtering at least a portion of ions other than the material vapor ions in the mixture comprises discharging ions other than the material vapor ions by the two parallel detector electrodes on the opposing walls of the filtering segment.

25. The method of claim 21, further comprising:
separating positive and negative ions by simultaneously applying the RF oscillating voltage and applying the second DC voltages to the two parallel filter electrodes on the opposing walls of the filtering segment.

26. The method of claim 21, further comprising:
removing the integrated oscillating field ion spectrometry device from the system when a sensitivity of the device falls below a threshold value; and
installing a replacement integrated oscillating field ion spectrometry device in the system.

27. A method of operating an integrated oscillating field ion spectrometry system including an integrated oscillating field ion spectrometry device, wherein the integrated oscillating field ion spectrometry device comprises a chamber divided into at least two segments comprising: a filtering segment and a detection segment arranged in order, wherein the detection segment is located after the filtering segment in a direction of flow of a carrier gas, the method comprising:
flowing, by the carrier gas, a mixture of the carrier gas and material vapor ions through the filtering segment and detection segment;
filtering at least a portion of ions other than the material vapor ions in the mixture by simultaneously applying an RF oscillating voltage and first DC voltages of opposite polarity to two parallel filter electrodes on opposing walls of the filtering segment; and
detecting the material vapor ions by applying second DC voltages to two parallel detector electrodes on opposing walls of the detection segment, and applying third DC voltages to two parallel ion guidance electrodes on the opposing walls of the detection segment, wherein the ion guidance electrodes surround a periphery of the detector electrodes.

28. The method of claim 27, further comprising:
providing a modifier gas to the mixture of the carrier gas and material vapor ions.

29. The method of claim 27, wherein the filtering at least a portion of ions other than the material vapor ions in the mixture comprises discharging ions other than the material vapor ions by the two parallel filter electrodes on the opposing walls of the filtering segment.

30. The method of claim 27, further comprising:
separating positive and negative ions by simultaneously applying the RF oscillating voltage and applying the first DC voltages to the two parallel filter electrodes on the opposing walls of the filtering segment.

31. The method of claim 27, further comprising:
removing the integrated oscillating field ion spectrometry device from the system when a sensitivity of the device falls below a threshold value; and
installing a replacement integrated oscillating field ion spectrometry device in the system.
